(19) United States
(12) Patent Application Publication
(10) Pub. No.: US 2026/0222564 A1
(43) Pub. Date: Jul. 30, 2026

(54) EFFICIENT CCSO FILTER DECISION MAKING IN VIDEO ENCODING

(71) Applicant: Intel Corporation, Santa Clara, CA (US)

(72) Inventors: Ximin Zhang, San Jose, CA (US); Yi-Jen Chiu, San Jose, CA (US)

(73) Assignee: Intel Corporation, Santa Clara, CA (US)

(21) Appl. No.: 19/577,856

(22) Filed: Mar. 25, 2026

(51) Int. Cl. H04N 19/117; H04N 19/124; H04N 19/14; H04N 19/147; H04N 19/172; H04N 19/82

(52) U.S. Cl. CPC H04N 19/117; H04N 19/124; H04N 19/14; H04N 19/147; H04N 19/172; H04N 19/82

(57) ABSTRACT

The cross-component sample offset (CCSO) filter is a significant in-loop filtering tool introduced in the AV2 video coding standard. The complexity of deriving frame-level CCSO filtering parameters involving a cascaded, pseudo-brute-force search across many combinations of the CCSO parameters is prohibitive for real-world encoder deployments and hardware implementations. This issue is addressed by introducing a hierarchical decision framework to selectively skip or drastically narrow the parameter search based on lightweight, content-adaptive analysis performed before the search begins. In some examples, frame type and encoded size determine whether to search, reuse reference parameters, or disable CCSO. When searching, sharp edge analysis adaptively restricts the candidate parameter space, thereby reducing search complexity significantly.

### BACKGROUND

Video compression is a technique for making video files smaller and easier to transmit over the Internet. There are different methods and algorithms for video compression, with different performance and trade-offs. Video compression involves encoding and decoding. Encoding is the process of transforming (uncompressed) video data into a compressed format. Decoding is the process of restoring video data from the compressed format. An encoder-decoder system is called a codec.

Cross-Component Sample Offset (CCSO) is an in-loop filtering tool that improves reconstructed video quality by using reconstructed luma samples, e.g., both co-located and neighboring samples, to derive offset corrections that are applied to reconstructed luma and chroma samples. In operation, CCSO first classifies each location using an edge-offset (EO) classifier and/or a band-offset (BO) classifier, then uses the resulting class index to look up an offset value from a frame-level lookup table (LUT) whose entries are signaled in the bitstream, and finally adds the offset to the corresponding reconstructed sample(s) to reduce coding artifacts and reconstruction error.

### BRIEF DESCRIPTION OF THE DRAWINGS

Examples will be readily understood by the following detailed description in conjunction with the accompanying drawings. To facilitate this description, like reference numerals designate like structural elements. Examples are illustrated by way of example, and not by way of limitation, in the figures of the accompanying drawings.

FIG. 1 illustrates an encoding system and a plurality of decoding systems, according to some examples of the disclosure.

FIG. 2 illustrates an exemplary encoder to encode video frames and output an encoded bitstream, according to some examples of the disclosure.

FIG. 3 illustrates an exemplary decoder to decode an encoded bitstream and output a decoded video, according to some examples of the disclosure.

FIG. 4 illustrates an in-loop filter and CCSO filtering decision part of an encoder, according to some examples of the disclosure.

FIG. 5 illustrates a CCSO filtering decision part, according to some examples of the disclosure.

FIG. 6 illustrates a CCSO filtering decision process, according to some examples of the disclosure.

FIG. 7 illustrates an adaptive CCSO parameter search path, according to some examples of the disclosure.

FIG. 8 illustrates a method for encoding a video, according to some examples of the disclosure.

FIG. 9 depicts a block diagram of an exemplary computing device, according to some examples of the disclosure.

### DETAILED DESCRIPTION

### Overview

Video coding or video compression is the process of compressing video data for storage, transmission, and playback. Video compression may involve taking a large amount of raw video data and applying one or more compression techniques to reduce the amount of data needed to represent the video while maintaining an acceptable level of visual quality. In some cases, video compression can offer efficient storage and transmission of video content over limited bandwidth networks.

A video includes one or more (temporal) sequences of video frames or frames. A frame may include an image, or a single still image. A frame may have millions of pixels. For example, a frame for an uncompressed 4K video may have a resolution of 3840×2160 pixels. Pixels may have luma/luminance and chroma/chrominance values. The terms “frame” and “picture” may be used interchangeably. There are several frame types or picture types. I-frames or intra-frames may be least compressible and do not depend on other frames to decode. I-frames may include scene change frames. P-frames may depend on data from previous frames to decode and may be more compressible than I-frames. B-frames may depend on data from previous and forward frames to decode and may be more compressible than I-frames and P-frames. Other frame types may include reference B-frame and non-reference B-frame. P-frames and B-frames may be referred to as inter-frames. The order in which I-frames, P-frames, and B-frames are arranged may be referred to as a group-of-pictures (GOP). A slice may be a spatially distinct region of a frame that is encoded separately from any other region in the same frame.

In some cases, a frame may be partitioned into one or more blocks. Blocks may be used for block-based compression. Blocks may have sizes which are much smaller, such as 512×512 pixels, 256×256 pixels, 128×128 pixels, 64×64 pixels, 32×32 pixels, 16×16 pixels, 8×8 pixels, 4×4 pixels, etc. A block may include a square or rectangular region of a frame. Various video compression techniques may use different terminology for the blocks or different partitioning structures for creating the blocks. In some video compression techniques, a frame may be partitioned into Coding Tree Units (CTUs). A CTU may be divided (separately for luma and chroma components) into Coding Tree Blocks (CTBs). A CTB can have a size of 64×64 pixels, 32×32 pixels, or 16×16 pixels. A CTB can be divided into Coding Units (CUs). A CU can be divided into Prediction Units (PUs) and/or discrete cosine transforms (DCT) Transform Units (TUs).

One of the tasks of an encoder in a video codec is to make encoding decisions at different levels for the video (e.g., sequence level, GOP level, frame/picture level, slice level, CTU level, CTB level, block-level, CU level, PU level, TU level, etc.), based on a desired bitrate and/or desired (objective and/or subjective) quality. Making encoding decisions may include evaluating different options or parameter values for encoding the data, and determining optimal options or parameter values that may achieve the desired bitrate and/or quality. The chosen option and/or parameter values may be applied to encode the video to generate a bitstream. The chosen option and/or parameter values would be encoded in the bitstream to signal to a decoder how to decode the encoded bitstream in accordance with the encoding decisions which were made by the encoder. Modern codecs offer a wide range of options and parameter values. While evaluating all possible combinations of options and parameter values may yield the most optimal encoding decision, an encoder does not have unlimited resources to afford the complexity that would be required to make globally optimal encoding decisions.

The Alliance for Open Media (AOMedia) has launched a next evolution in open video coding: AOMedia Video 2 (AV2). AV2 is not only an upgrade to the widely adopted AOMedia Video 1 (AV1), AV2 is also a foundational piece of AOMedia's future tech stack. As a generation leap in open video coding and the answer to the world's growing streaming demands, AV2 delivers significantly better compression efficiency than AV1. AV2 has achieved over 30% subjective quality improvement with similar bitrates and is designed to meet various future demands. In general, AV2 offers significant technical advantages over its predecessors AV1 with the expense of ~30× average complexity increase in typical test conditions.

The CCSO filter is one of the in-loop filtering tools introduced in the AV2 video coding standard. CCSO uses co-located and neighboring reconstructed luma samples as inputs to derive correction offsets, which are applied to both luma and co-located chroma reconstructed samples to reduce coding artifacts and improve objective quality. The process takes reconstructed luma samples as input and produces offset values applied to central luma or co-located chroma samples. For each picture, the picture level filter sets are first derived for each color channel. After that, block-level decisions are made for each filter unit. CCSO has been demonstrated to effectively remove coding artifacts and improve objective quality measurement at the same time.

At the frame-level, CCSO filtering is governed by up to eleven syntax elements (referred to herein as CCSO filtering parameters) including scale index, filter shape index, quantization step index, number of bands, EO quantizer type, and per-class LUT offset values, while a block-level on/off flag is additionally signaled per filter unit. The derivation of the group of frame-level syntaxes involves evaluating different combinations of model parameters through cascaded loops. The total number of combinations is massive. Even including early-exit optimizations, the derivation of these frame-level parameters in the AV2 reference encoder (AVM) relies on a cascaded, pseudo-brute-force search across all combinations of the above parameters, resulting in approximately 1,000 loop iterations per color channel per frame to determine the final CCSO parameters for every color channel of each frame. This complexity is prohibitive for real-world encoder deployments and hardware implementations.

To address the complexity issue of implementing CCSO filtering in an encoder, a hierarchical decision framework, referred to herein as a CCSO filtering decision tree, is introduced. The CCSO filtering decision tree selectively skips or drastically narrows the parameter search based on lightweight, content-adaptive analysis performed before the search begins. The methodology can significantly reduce or eliminate the frame-level loop searches when deriving the CCSO filtering decisions (e.g., the group of frame-level syntaxes or CCSO filtering parameters).

The CCSO filtering decision tree includes frame type and size analysis. Based on the analysis, a frame may undergo an adaptive CCSO parameter search, a truncated CCSO parameter search, or CCSO may be skipped altogether. The adaptive CCSO parameter search has higher complexity than the truncated CCSO parameter search. Skipping CCSO filtering has the least complexity, since no parameter search would be performed.

In some examples, intra-frames and anchor frames (e.g., the lowest-quantization-parameter reference frame within each group-of-pictures, such as a B0 frame in a group-of-pictures having eight frames (GOP8) hierarchical structure) can undergo the adaptive CCSO parameter search, since these frames are the most important reference points for subsequent frames and quality investments at these frames propagate widely.

In some examples, for all other frames, such as inter-frames, the decision tree examines the encoded bitstream size of a most recently encoded frame, such as a nearest lower-layer reference frame in the hierarchical coding order. For example, a B1 frame in a GOP8 hierarchical structure inspects the size of the most recently encoded B0 frame, and a B2 frame inspects the most recently encoded B1 frame. This encoded bitstream size, referred to as the encoded frame size, serves as a proxy for the visual complexity and information content of the scene in the current frame. The proxy can be used to determine whether the frame would undergo an adaptive CCSO parameter search, a truncated CCSO parameter search, or CCSO may be skipped altogether.

In some examples, the encoded frame size is compared against one or more (e.g., two) thresholds in the decision tree. If the encoded frame size exceeds a first (e.g., higher) threshold, the current frame is deemed sufficiently complex to warrant the adaptive CCSO parameter search process. If the frame size falls between the two thresholds, the frame may undergo the truncated CCSO parameter search, where only the CCSO parameter sets already derived for the reference frames are evaluated, and the set with the lowest rate-distortion cost is selected. In the truncated CCSO parameter search, any new parameter search can be avoided while still adapting to available information. If the encoded frame size falls below the second (e.g., lower) threshold, the scene is considered sufficiently low-complexity that CCSO is disabled entirely for the current frame, yielding the maximum possible complexity reduction with negligible quality impact.

When the adaptive CCSO parameter search is determined to be applied to the frame, a sharp edge analysis is applied to the current frame prior to parameter search. Sharp edge content is quantified by computing the variance of blocks across the frame, and the percentage of blocks exceeding a sharpness threshold is derived as Pₛₕₐᵣₚ. This sharpness metric, Pₛₕₐᵣₚ, serves as a content-adaptive signal that can steer filter parameter candidate selection for one or more parameter dimensions simultaneously: the quantization step range, the EO filter shape subset, and implicitly the sensitivity of the EO classifier. Effectively, Pₛₕₐᵣₚ is used to select an optimal set of candidate filter parameters from different sets of candidate filter parameters that best suits the given frame and to eliminate, early before the search begins, ineffective filter parameter sets that are rarely chosen in practice.

The relationship between sharpness and parameter selection is grounded in the physics of CCSO classification. The EO classifier computes delta values between the central sample and its neighbors and quantizes them against a threshold T to assign an edge class. For sharp edge content, these delta values are inherently large, so a larger quantization step T is used to meaningfully differentiate classes and avoid collapsing most pixels into a single class. Additionally, for sharp edges, the immediate neighbors (e.g., positions adjacent to the central sample) carry the most discriminative information, favoring filter shapes that use nearby spatial offsets. Conversely, for smooth content, smaller T values provide finer discrimination among subtly varying regions, and more distant neighbor positions provide useful context.

In some examples, based on Pₛₕₐᵣₚ, scale index candidates (e.g., scale_idx) are adaptively restricted. If Pₛₕₐᵣₚ is below the threshold (e.g., suggesting smooth content), only scale_idx=1 is selected. Quantization steps T∈{0, 8, 16, 32} and EO filter shapes 0, 1, 5, 6 (which use more distant neighbors) are selected. If Pₛₕₐᵣₚ meets or exceeds the threshold (e.g., suggesting sharp content), scale_idx=1 and scale_idx=2 are both selected. Quantization steps T∈{0, 8, 16, 32} and {40, 56, 64, 128} and EO filter shapes 0, 1, 2, 3 (which use nearer neighbors) are selected. This adaptive selection based on Pₛₕₐᵣₚ reduces the scale and filter shape search space from 4×7 combinations to a content-specific subset of 4 or fewer, corresponding to a substantial fraction of the overall search reduction.

In some examples, during the adaptive CCSO parameter search, the EO quantizer type is fixed exclusively to the three-interval quantizer across all frames and content types. The AV2 standard supports both a two-interval and a three-interval EO quantizer. The two-interval quantizer is a strict subset of the three-interval quantizer in terms of classification capacity, offering slightly lower bitrate overhead for signaling offset parameters but providing coarser edge classification. Empirical analysis demonstrated that for most content, the three-interval quantizer yields equal or better rate-distortion performance. The marginal gain from searching both types does not justify more than doubling the associated search complexity. Therefore, the two-interval quantizer is excluded entirely from the candidate parameter set.

In some examples, during the adaptive CCSO parameter search, for the BO classifier in the joint BO+EO configuration, the number of bands candidates are restricted by fixed rules derived from empirical observation. When EO and BO are used jointly, only max_band_log_2=6 (e.g., 64 bands) is searched for the luma channel, and only max_band_log_2=4 (e.g., 16 bands) is searched for the chroma channels. The rationale is that empirical testing showed the BO component, when jointly applied with EO in inter-frames, is almost never selected in practice, and when it is selected, the maximum band count consistently yields the best result.

In some examples, during the adaptive CCSO parameter search, when only BO is used (a mode of interest for very low-complexity encoder configurations), max_band_log_2=6 and 5 (e.g., 64 and 32 bands) are searched for luma, and max_band_log_2=5 and 4 (e.g., 32 and 16 bands) are searched for chroma. The rationale for using more bands rather than fewer is that a single band provides no classification at all—the entire frame would receive one uniform offset-so a meaningful minimum number of bands is required for any quality gain, and the maximum band counts are where quality improvements are concentrated.

In some examples, during the adaptive CCSO parameter search, for intra-frames, the band-only check, meaning the BO-only mode or where the BO classifier operates independently with the EO classifier, can be skipped entirely. For intra-frames, BO-only mode almost never gets selected in empirical studies because intra-frames are rich in residual content where joint EO and BO mode almost always wins. Eliminating the BO-only branch is a safe additional complexity reduction within the adaptive CCSO parameter search. The encoder may evaluate the joint EO and BO mode or configuration only.

The effect of the decision tree is a drastic reduction in parameter search complexity. When the adaptive CCSO parameter search is used, over 93% of parameter combination evaluations are eliminated relative to the reference AVM encoder. When the frame type and size analysis permits skipping the adaptive search and applying the truncated CCSO parameter search (e.g., by selecting from reference frame parameters) or disabling CCSO altogether, over 99% of combination searches are bypassed.

Validation on AV2 reference encoder test sequences across multiple resolutions shows that the technique retains an average of approximately 95% of the full Bjontegaard Delta Rate (BD rate) gain achievable with brute-force search, at roughly 5% of the original encoding complexity for the CCSO parameter derivation process.

Techniques for making CCSO filtering decisions described and illustrated herein may be applied to a variety of codecs that may utilize CCSO filtering as an in-loop filter. Examples of codecs can include AVC (Advanced Video Coding), HEVC (High Efficiency Video Coding), AV1, AV2, and VVC (Versatile Video Coding). AVC, also known as “ITU-T H.264”, was approved in 2003 and last revised 2021 Aug. 22. HEVC, also known as “ITU-T H.265”, was approved in 2013 and last revised 2023 Sep. 13. AV1 is a video coding codec designed for video transmissions over the Internet. “AV1 Bitstream & Decoding Process Specification” version 1.1.1 with Errata was last modified in 2019. AOM Working Group Approved Draft, “AV2 Bitstream & Decoding Process Specification,” was published 5 Jan. 2026. VVC, also known as “ITU-T H.266”, was finalized in 2020. While the techniques described herein relate to AV2, it is envisioned by the disclosure that the techniques may be applied to other codecs having the CCSO filter as an in-loop filter.

### Video Compression

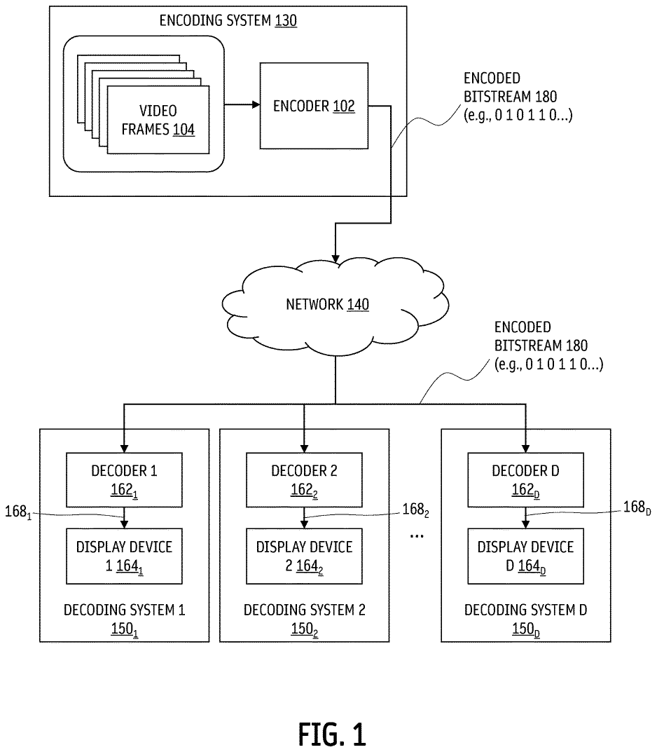

FIG. 1 illustrates encoding system 130 and one or more decoding systems 150_{1 . . . D}, according to some examples of the disclosure.

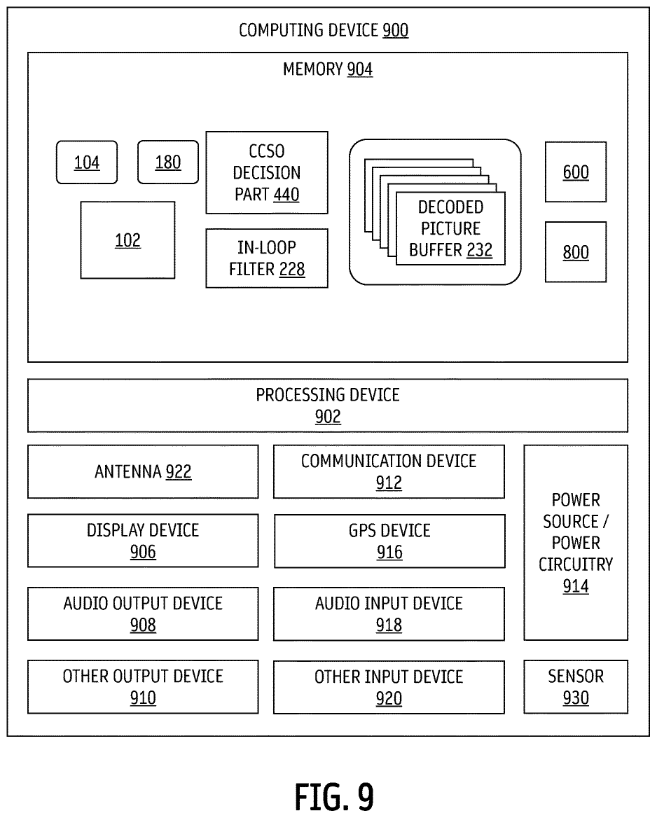

Encoding system 130 may be implemented on computing device 900 of FIG. 9. Encoding system 130 can be implemented in the cloud or in a data center. Encoding system 130 can be implemented on a device that is used to capture the video. Encoding system 130 can be implemented on a standalone computing system. Encoding system 130 may perform the process of encoding in video compression. Encoding system 130 may receive a video (e.g., uncompressed video, original video, raw video, etc.) comprising a sequence of video frames 104. The video frames 104 may include image frames or images that make up the video. A video may have a frame rate or number of frames per second (FPS), that defines the number of frames per second of video. The higher the FPS, the more realistic and fluid the video looks. Typically, FPS is greater than 24 frames per second for a natural, realistic viewing experience to a human viewer. Examples of video may include a television episode, a movie, a short film, a short video (e.g., less than 15 seconds long), a video capturing gaming experience, computer screen content, video conferencing content, live event broadcast content, sports content, a surveillance video, a video shot using a mobile computing device (e.g., a smartphone), etc. In some cases, video may include a mix or combination of different types of video.

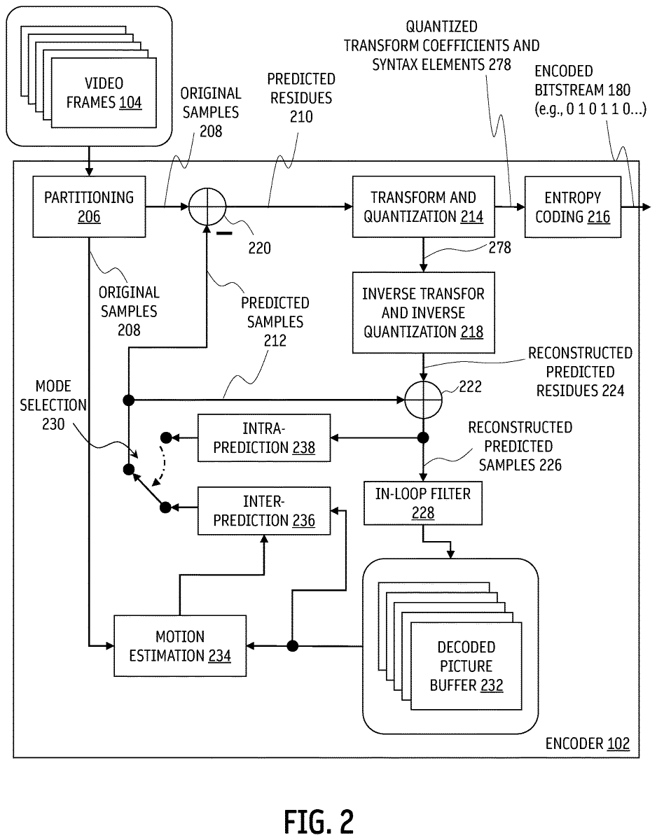

Encoding system 130 may include encoder 102 that receives video frames 104 and encodes video frames 104 into encoded bitstream 180. An exemplary implementation of encoder 102 is illustrated in FIG. 2.

Encoded bitstream 180 may be compressed, meaning that encoded bitstream 180 may be smaller in size than video frames 104. Encoded bitstream 180 may include a series of bits, e.g., having 0's and 1's. Encoded bitstream 180 may have header information, payload information, and footer information, which may be encoded as bits in the bitstream. Header information may provide information about one or more of: the format of encoded bitstream 180, the encoding process implemented in encoder 102, the parameters of encoder 102, and metadata of encoded bitstream 180. For example, header information may include one or more of: resolution information, frame rate, aspect ratio, color space, etc. Payload information may include data representing content of video frames 104, such as samples, frames, symbols, syntax elements, etc. For example, payload information may include bits that encode one or more of motion predictors, transform coefficients, prediction modes, and quantization levels of video frames 104. Footer information may indicate an end of the encoded bitstream 180. Footer information may include other information including one or more of: checksums, error correction codes, and signatures. The format of encoded bitstream 180 may vary depending on the specification of the encoding and decoding process, i.e., the codec.

Encoded bitstream 180 may include packets, where encoded video data and signaling information may be packetized. One exemplary format is the Open Bitstream Unit (OBU), which is used in AV1 encoded bitstreams. An OBU may include a header and a payload. The header can include information about the OBU, such as information that indicates the type of OBU. Examples of OBU types may include sequence header OBU, frame header OBU, metadata OBU, temporal delimiter OBU, and tile group OBU. Payloads in OBUs may carry quantized transform coefficients and syntax elements that may be used in the decoder to properly decode the encoded video data to regenerate video frames.

Encoded bitstream 180 may be transmitted to one or more decoding systems 150_{1 . . . D}, via network 140. Network 140 may be the Internet. Network 140 may include one or more of: cellular data networks, wireless data networks, wired data networks, cable Internet networks, fiber optic networks, satellite Internet networks, etc.

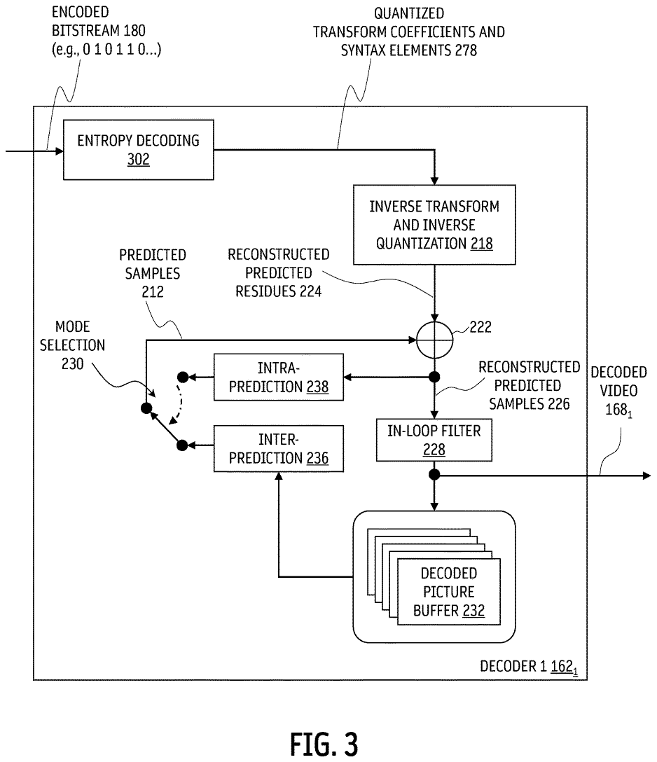

D number of decoding systems 150_{1 . . . D} are illustrated. At least one of the decoding systems 150_{1 . . . D} may be implemented on computing device 900 of FIG. 9. Examples of systems 150_{1 . . . D} may include personal computers, mobile computing devices, gaming devices, augmented reality devices, mixed reality devices, virtual reality devices, televisions, etc. Each one of decoding systems 150_{1 . . . D} may perform the process of decoding in video compression. Each one of decoding systems 150_{1 . . . D} may include a decoder (e.g., decoder 1 . . . D 162_{1 . . . D}), and one or more display devices (e.g., display device 1 . . . D 164_{1 . . . D}). An exemplary implementation of a decoder, e.g., decoder 1 162₁, is illustrated in FIG. 3.

For example, decoding system 1 150₁, may include decoder 1 162₁ and a display device 1 164₁. Decoder 1 162₁ may implement a decoding process of video compression. Decoder 1 162₁ may receive encoded bitstream 180 and produce decoded video 168₁. Decoded video 168₁ may include a series of video frames, which may be a version or reconstructed version of video frames 104 encoded by encoding system 130. Display device 1 164₁ may output the decoded video 168₁ for display to one or more human viewers or users of decoding system 1 150₁.

For example, decoding system 2 150₂, may include decoder 2 162₂ and a display device 2 164₂. Decoder 2 162₂ may implement a decoding process of video compression. Decoder 2 162₂ may receive encoded bitstream 180 and produce decoded video 168₂. Decoded video 168₂ may include a series of video frames, which may be a version or reconstructed version of video frames 104 encoded by encoding system 130. Display device 2 164₂ may output the decoded video 168₂ for display to one or more human viewers or users of decoding system 2 150₂.

For example, decoding system D 150_{D}, may include decoder D 162_{D} and a display device D 164_{D}. Decoder D 162_{D} may implement a decoding process of video compression. Decoder D 162_{D} may receive encoded bitstream 180 and produce decoded video 168_{D}. Decoded video 168_{D} may include a series of video frames, which may be a version or reconstructed version of video frames 104 encoded by encoding system 130. Display device D 164_{D} may output the decoded video 168_{D} for display to one or more human viewers or users of decoding system D 150_{D}.

### Video Encoder

FIG. 2 illustrates encoder 102 to encode video frames and output an encoded bitstream, according to some examples of the disclosure. Encoder 102 may include one or more of: signal processing operations and data processing operations, including inter- and intra-prediction, transform, quantization, in-loop filtering, and entropy coding. Encoder 102 may include a reconstruction loop involving inverse quantization, and inverse transformation to guarantee that the decoder would see the same reference blocks and frames. Encoder 102 may receive video frames 104 and encode video frames 104 into encoded bitstream 180. Encoder 102 may include one or more of partitioning 206, transform and quantization 214, inverse transform and inverse quantization 218, in-loop filter 228, motion estimation 234, inter-prediction 236, intra-prediction 238, and entropy coding 216.

Partitioning 206 may divide a frame in video frames 104 into blocks of pixels. Different codecs may allow different variable ranges of block sizes. In one codec, a frame may be partitioned by partitioning 206 into blocks of size 128×128 or 64×64 pixels. In some cases, a frame may be partitioned by partitioning 206 into blocks of size 32×32 pixels or 16×16 pixels. In some cases, a frame may be partitioned by partitioning 206 into blocks of 256×256 or 512×512 pixels. Large blocks may be referred to as superblocks. Partitioning 206 may further divide each superblock using a multi-way partition tree structure. In some cases, a partition of a superblock can be recursively divided further by partitioning 206 using the multi-way partition tree structure (e.g., down to 4×4 size blocks). In another codec, a frame may be partitioned by partitioning 206 into CTUs of size 128×128 pixels. Partitioning 206 may divide a CTU using a quadtree partitioning structure into four CUs. Partitioning 206 may further recursively divide a CU using the quadtree partitioning structure. Partitioning 206 may (further) subdivide a CU using a multi-type tree structure (e.g., a quadtree, a binary tree, or ternary tree structure). A smallest CU may have a size of 4×4. Partitioning 206 may output original samples 208, e.g., as blocks of pixels.

Intra-prediction 238 may predict samples of a block from reconstructed predicted samples of previously encoded spatial neighboring/reference blocks of the same frame. Intra-prediction 238 may receive reconstructed predicted samples 226 (of previously encoded spatial neighbor blocks of the same frame). Reconstructed predicted samples 226 may be generated by summer 222 from reconstructed predicted residues 224 and predicted samples 212. Intra-prediction 238 may determine a suitable predictor for predicting the samples from reconstructed predicted samples of previously encoded spatial neighboring/reference blocks of the same frame. Intra-prediction 238 may generate predicted samples 212 using the suitable predictor. Intra-prediction 238 may output or identify the neighboring/reference block and a predictor used in generating the predicted samples 212. The identified neighboring/reference block and predictor may be encoded in the encoded bitstream 180 to enable a decoder to reconstruct a block using the same neighboring/reference block and predictor. In one codec, intra-prediction 238 may support a number of diverse predictors, e.g., 56 different predictors. Some predictors, e.g., directional predictors, may capture different spatial redundancies in directional textures. Pixel values of a block can be predicted using a directional predictor in intra-prediction 238 by extrapolating pixel values of a neighboring/reference block along a certain direction. Intra-prediction 238 of different codecs may support different sets of predictors to exploit different spatial patterns within the same frame. Examples of predictors may include direct current (DC), planar, Paeth, smooth, smooth vertical, smooth horizontal, recursive-based filtering modes, chroma-from-luma, intra-block copy, color palette, multiple-reference line, intra-sub-partition, matrix-based intra-prediction (matrix coefficients may be defined by offline training using neural networks), wide-angle prediction, cross-component linear model, template matching, etc. In some cases, intra-prediction 238 may perform block-prediction, where a predicted block may be produced from a reconstructed neighboring/reference block of the same frame using a vector. Optionally, an interpolation filter of a certain type may be applied to the predicted block to blend pixels of the predicted block. Pixel values of a block can be predicted using a vector compensation process in intra-prediction 238 by translating a neighboring/reference block (within the same frame) according to the vector (and optionally applying an interpolation filter to the neighboring/reference block) to produce predicted samples 212. Intra-prediction 238 may output or identify the vector applied in generating predicted samples 212. In some codecs, intra-prediction 238 may encode (1) a residual vector generated from the applied vector and a vector predictor candidate, and (2) information that identifies the vector predictor candidate, rather than encoding the applied vector itself. Intra-prediction 238 may output or identify an interpolation filter type applied in generating predicted samples 212.

Motion estimation 234 and inter-prediction 236 may predict samples of a block from samples of previously encoded frames, e.g., reference frames in decoded picture buffer 232. Motion estimation 234 and inter-prediction 236 may perform motion compensation, which may involve identifying a suitable reference block and a suitable motion predictor (or vector) for a block and optionally an interpolation filter to be applied to the reference block. Motion estimation 234 may receive original samples 208 from partitioning 206. Motion estimation 234 may receive samples from decoded picture buffer 232 (e.g., samples of previously encoded frames or reference frames). Motion estimation 234 may use a number of reference frames for determining one or more suitable motion predictors. A motion predictor may include a reference block and a motion vector that can be applied to generate a motion-compensated block or predicted block. Motion predictors may include motion vectors that capture the movement of blocks between frames in a video. Motion estimation 234 may output or identify one or more reference frames and one or more suitable motion predictors. Inter-prediction 236 may apply the one or more suitable motion predictors determined in motion estimation 234 and one or more reference frames to generate predicted samples 212. The identified reference frame(s) and motion predictor(s) may be encoded in the encoded bitstream 180 to enable a decoder to reconstruct a block using the same reference frame(s) and motion predictor(s). In one codec, motion estimation 234 may implement single reference frame prediction mode, where a single reference frame with a corresponding motion predictor is used for inter-prediction 236. Motion estimation 234 may implement compound reference frame prediction mode where two reference frames with two corresponding motion predictors are used for inter-prediction 236. In one codec, motion estimation 234 may implement techniques for searching and identifying good reference frame(s) that can yield the most efficient motion predictor. The techniques in motion estimation 234 may include searching for good reference frame(s) candidates spatially (within the same frame) and temporally (in previously encoded frames). The techniques in motion estimation 234 may include searching a deep spatial neighborhood to find a spatial candidate pool. The techniques in motion estimation 234 may include utilizing temporal motion field estimation mechanisms to generate a temporal candidate pool. The techniques in motion estimation 234 may use a motion field estimation process. After temporal and spatial candidates may be ranked and a suitable motion predictor may be determined. In one codec, inter-prediction 236 may support a number of diverse motion predictors. Examples of predictors may include geometric motion vectors (complex, non-linear motion), warped motion compensation (affine transformations that capture non-translational object movements), overlapped block motion compensation, advanced compound prediction (compound wedge prediction, difference-modulated masked prediction, frame distance-based compound prediction, and compound inter-intra prediction), dynamic spatial and temporal motion vector referencing, affine motion compensation (capturing higher-order motion such as rotation, scaling, and shearing), adaptive motion vector resolution modes, geometric partitioning modes, bidirectional optical flow, prediction refinement with optical flow, bi-prediction with weights, extended merge prediction, etc. Optionally, an interpolation filter of a certain type may be applied to the predicted block to blend pixels of the predicted block. Pixel values of a block can be predicted using the motion predictor/vector determined in a motion compensation process in motion estimation 234 and inter-prediction 236 and optionally applying an interpolation filter. In some cases, inter-prediction 236 may perform motion compensation, where a predicted block may be produced from a reconstructed reference block of a reference frame using the motion predictor/vector. Inter-prediction 236 may output or identify the motion predictor/vector applied in generating predicted samples 212. In some codecs, inter-prediction 236 may encode (1) a residual vector generated from the applied vector and a vector predictor candidate, and (2) information that identifies the vector predictor candidate, rather than encoding the applied vector itself. Inter-prediction 236 may output or identify an interpolation filter type applied in generating predicted samples 212.

Mode selection 230 may be informed by components such as motion estimation 234 to determine whether inter-prediction 236 or intra-prediction 238 may be more efficient for encoding a block (thus making an encoding decision). Inter-prediction 236 may output predicted samples 212 of a predicted block. Inter-prediction 236 may output a selected predictor and a selected interpolation filter (if applicable) that may be used to generate the predicted block. Intra-prediction 238 may output predicted samples 212 of a predicted block. Intra-prediction 238 may output a selected predictor and a selected interpolation filter (if applicable) that may be used to generate the predicted block. Regardless of the mode, predicted residues 210 may be generated by subtractor 220 by subtracting original samples 208 from predicted samples 212. In some cases, predicted residues 210 may include residual vectors from inter-prediction 236 and/or intra-prediction 238.

Transform and quantization 214 may receive predicted residues 210. Predicted residues 210 may be generated by subtractor 220 that takes original samples 208 and subtracts predicted samples 212 to output predicted residues 210. Predicted residues 210 may be referred to as prediction error of the intra-prediction 238 and inter-prediction 236 (e.g., error between the original samples and predicted samples 212). Prediction error has a smaller range of values than the original samples and can be coded with fewer bits in encoded bitstream 180. Transform and quantization 214 may include one or more of transforming and quantizing. Transforming may include converting the predicted residues 210 from the spatial domain to the frequency domain. Transforming may include applying one or more transform kernels. Examples of transform kernels may include horizontal and vertical forms of DCT, asymmetrical discrete sine transform (ADST), flip ADST, and identity transform (IDTX), multiple transform selection, low-frequency non-separable transform, subblock transform, non-square transforms, DCT-VIII, discrete sine transform VII (DST-VII), discrete wavelet transform (DWT), etc. Transforming may convert the predicted residues 210 into transform coefficients. Quantizing may quantize the transformed coefficients, e.g., by reducing the precision of the transform coefficients. Quantizing may include using quantization matrices (e.g., linear and non-linear quantization matrices). The elements in the quantization matrix can be larger for higher frequency bands and smaller for lower frequency bands, which means that the higher frequency coefficients are more coarsely quantized, and the lower frequency coefficients are more finely quantized. Quantizing may include dividing each transform coefficient by a corresponding element in the quantization matrix and rounding to the nearest integer. Effectively, the quantization matrices may implement different QPs for different frequency bands and chroma planes and can use spatial prediction. A suitable quantization matrix can be selected and signaled for each frame and encoded in encoded bitstream 180. Transform and quantization 214 may output quantized transform coefficients and syntax elements 278 that indicate the coding modes and parameters used in the encoding process implemented in encoder 102.

Inverse transform and inverse quantization 218 may apply the inverse operations performed in transform and quantization 214 to produce reconstructed predicted residues 224 as part of a reconstruction path to produce decoded picture buffer 232 for encoder 102. Inverse transform and inverse quantization 218 may receive quantized transform coefficients and syntax elements 278. Inverse transform and inverse quantization 218 may perform one or more inverse quantization operations, e.g., applying an inverse quantization matrix, to obtain the unquantized/original transform coefficients. Inverse transform and inverse quantization 218 may perform one or more inverse transform operations, e.g., inverse transform (e.g., inverse DCT, inverse DWT, etc.), to obtain reconstructed predicted residues 224. A reconstruction path is provided in encoder 102 to generate reference blocks and frames, which are stored in decoded picture buffer 232. The reference blocks and frames may match the blocks and frames to be generated in the decoder. The reference blocks and frames are used as reference blocks and frames by motion estimation 234, inter-prediction 236, and intra-prediction 238.

In-loop filter 228 may implement filters to smooth out artifacts introduced by the encoding process in encoder 102 (e.g., processing performed by partitioning 206 and transform and quantization 214). In-loop filter 228 may receive reconstructed predicted samples 226 from summer 222 and output frames to decoded picture buffer 232. Examples of in-loop filters may include CCSO filter, guided detail filter (GDF), constrained low-pass filter, directional deringing filter, edge-directed conditional replacement filter, loop-restoration filter, Wiener filter, self-guided restoration filters, constrained directional enhancement filter (CDEF), Luma Mapping with Chroma Scaling (LMCS), Sample Adaptive Offset (SAO) filter, Adaptive Loop Filter (ALF), cross-component ALF, low-pass filter, deblocking filter, etc. For example, applying a deblocking filter across a boundary between two blocks can resolve blocky artifacts caused by the Gibbs phenomenon. In some examples, in-loop filter 228 may fetch data from a frame buffer having reconstructed predicted samples 226 of various blocks of a video frame. Encoder 102 may determine whether to apply an in-loop filter or not. Encoder 102 may determine one or more suitable filters that achieve good visual quality and/or one or more suitable filters that suitably remove the artifacts introduced by the encoding process in encoder 102. After applying the one or more (suitable) filters, in-loop filter 228 may write (filtered) reconstructed samples to a frame buffer, such as decoded picture buffer 232.

Entropy coding 216 may receive quantized transform coefficients and syntax elements 278 (e.g., referred to herein as symbols) and perform entropy coding. Entropy coding 216 may generate and output encoded bitstream 180. Entropy coding 216 may exploit statistical redundancy and apply lossless algorithms to encode the symbols and produce a compressed bitstream, e.g., encoded bitstream 180. Entropy coding 216 may implement some version of arithmetic coding. Different versions may have different pros and cons. In one codec, entropy coding 216 may implement (symbol-to-symbol) adaptive multi-symbol arithmetic coding. In another codec, entropy coding 216 may implement context-based adaptive binary arithmetic coder (CABAC). Binary arithmetic coding differs from multi-symbol arithmetic coding. Binary arithmetic coding encodes only a bit at a time, e.g., having either a binary value of 0 or 1. Binary arithmetic coding may first convert each symbol into a binary representation (e.g., using a fixed number of bits per symbol). Handling just a binary value of 0 or 1 can simplify computation and reduce complexity. Binary arithmetic coding may assign a probability to each binary value (e.g., a chance of the bit having a binary value of 0 and a chance of the bit having a binary value of 1). Multi-symbol arithmetic coding performs encoding for an alphabet having at least two or three symbol values and assigns a probability to each symbol value in the alphabet. Multi-symbol arithmetic coding can encode more bits at a time, which may result in a fewer number of operations for encoding the same amount of data. Multi-symbol arithmetic coding can require more computation and storage (since probability estimates may be updated for every element in the alphabet). Maintaining and updating probabilities (e.g., cumulative probability estimates) for each possible symbol value in multi-symbol arithmetic coding can be more complex (e.g., complexity grows with alphabet size). Multi-symbol arithmetic coding is not to be confused with binary arithmetic coding, as the two different entropy coding processes are implemented differently and can result in different encoded bitstreams for the same set of quantized transform coefficients and syntax elements 278.

### Video Decoder

FIG. 3 illustrates decoder 1 162₁ to decode an encoded bitstream and output a decoded video, according to some examples of the disclosure. Decoder 1 162₁ may include one or more of: signal processing operations and data processing operations, including entropy decoding, inverse transform, inverse quantization, inter and intra-prediction, in-loop filtering, etc. Decoder 1 162₁ may have signal and data processing operations that mirror the operations performed in the encoder. Decoder 1 162₁ may apply signal and data processing operations that are signaled in encoded bitstream 180 to reconstruct the video. Decoder 1 162₁ may receive encoded bitstream 180 and generate and output decoded video 168₁ having a plurality of video frames. The decoded video 168₁ may be provided to one or more display devices for display to one or more human viewers. Decoder 1 162₁ may include one or more of entropy decoding 302, inverse transform and inverse quantization 218, in-loop filter 228, inter-prediction 236, and intra-prediction 238. Some of the functionalities are previously described and used in the encoder, such as encoder 102 of FIG. 2.

Entropy decoding 302 may decode the encoded bitstream 180 and output symbols that were coded in the encoded bitstream 180. The symbols may include quantized transform coefficients and syntax elements 278. Entropy decoding 302 may reconstruct the symbols from the encoded bitstream 180.

Inverse transform and inverse quantization 218 may receive quantized transform coefficients and syntax elements 278 and perform operations which are performed in the encoder. Inverse transform and inverse quantization 218 may output reconstructed predicted residues 224. Summer 222 may receive reconstructed predicted residues 224 and predicted samples 212 and generate reconstructed predicted samples 226. Inverse transform and inverse quantization 218 may output syntax elements 278 having signaling information for informing/instructing/controlling operations in decoder 1 162₁, such as mode selection 230, intra-prediction 238, inter-prediction 236, and in-loop filter 228.

Depending on the prediction modes signaled in the encoded bitstream 180 (e.g., as syntax elements in quantized transform coefficients and syntax elements 278), intra-prediction 238 or inter-prediction 236 may be applied to generate predicted samples 212.

Summer 222 may sum predicted samples 212 of a decoded reference block and reconstructed predicted residues 224 to produce reconstructed predicted samples 226 of a reconstructed block. For intra-prediction 238, the decoded reference block may be in the same frame as the block that is being decoded or reconstructed. For inter-prediction 236, the decoded reference block may be in a different (reference) frame in decoded picture buffer 232.

Intra-prediction 238 may determine a reconstructed vector based on a residual vector and a selected vector predictor candidate. Intra-prediction 238 may apply a reconstructed predictor or vector (e.g., in accordance with signaled predictor information) to the reconstructed block, which may be generated using a decoded reference block of the same frame. Intra-prediction 238 may apply a suitable interpolation filter type (e.g., in accordance with signaled interpolation filter information) to the reconstructed block to generate predicted samples 212.

Inter-prediction 236 may determine a reconstructed vector based on a residual vector and a selected vector predictor candidate. Inter-prediction 236 may apply a reconstructed predictor or vector (e.g., in accordance with signaled predictor information) to a reconstructed block, which may be generated using a decoded reference block of a different frame from decoded picture buffer 232. Inter-prediction 236 may apply a suitable interpolation filter type (e.g., in accordance with signaled interpolation filter information) to the reconstructed block to generate predicted samples 212.

In-loop filter 228 may receive reconstructed predicted samples 226. In-loop filter 228 may apply one or more filters signaled in the encoded bitstream 180 to the reconstructed predicted samples 226. In-loop filter 228 may output decoded video 168₁.

### In-Loop Filtering, CCSO Filtering Details, and CCSO Filtering Decision Making

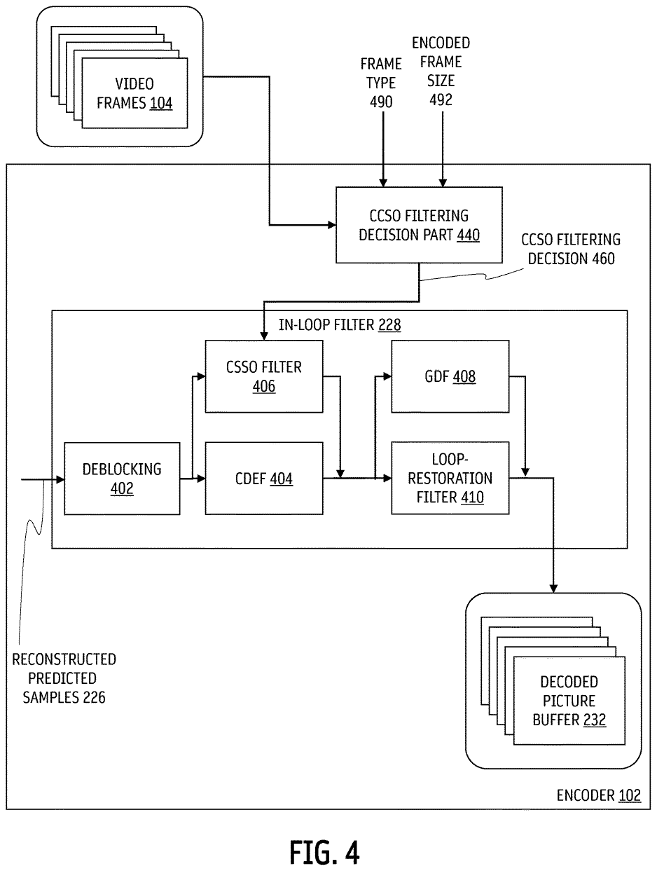

FIG. 4 illustrates in-loop filter 228 and CCSO filtering decision part 440 of encoder 102, according to some examples of the disclosure. In-loop filter 228 may be applied to reconstructed predicted samples 226, and post-filtering output may be output to decoded picture buffer 232. Decoded picture buffer 232 may be used as a reference for inter-prediction (e.g., inter-prediction 236 of FIG. 2). In some video compression techniques, in-loop filter 228 may include a pipeline or series of in-loop filters, which may be individually or selectively disabled or enabled by syntax elements in the encoded bitstream.

In AV2, in-loop filter 228 can include one or more of: deblocking filter 402, CDEF 404, CCSO filter 406, loop-restoration filter 410, and GDF 408. Deblocking filter 402 receives reconstructed predicted samples 226 as input and provides filtered output to both CCSO filter 406 and CDEF 404, which operate in parallel on the post-deblocking samples. CCSO filter 406 can derive correction offsets from reconstructed luma samples and apply them to luma and chroma components to reduce coding artifacts. CDEF 404 can perform constrained directional enhancement on the reconstructed samples independently of CCSO filter 406. The output of CCSO filter 406 is applied on the output of CDEF 404 output, and is subsequently provided as input to loop-restoration filter 410 and optionally to GDF 408. Loop-restoration filter 410 can produce a final filtered output for the in-loop filter pipeline. In some examples, CCSO filter 406 and CDEF 404 may operate concurrently without mutual dependency, eliminating pipeline stalls and reducing hardware buffering requirements.

The filtering process of CCSO filter 406 involves three operations. First, the current reconstructed luma samples are classified using two types of classifiers: the EO classifier and the BO classifier. These classifiers can operate jointly or individually based on indicators signaled at the frame-level. Second, the class associated with the current luma sample is used as an index to fetch offset values from a LUT, which is determined at the frame-level with entries selected from a limited number of predefined values. This LUT is shared across the entire frame for each color channel. Finally, the derived offset values using the LUT and class index are added to the corresponding luma and chroma components. A filter unit-level on/off flag is signaled to indicate whether CCSO filtering is applied for the associated filter unit.

BO classifier can be used in conjunction with the EO classifier or independently. A frame-level flag is signaled to indicate whether the current frame uses only the BO classifier or combines or jointly uses both the BO and EO classifiers. In both scenarios, the B0 index, BO_{idx}, is derived by using:

$${BO}_{idx} = {I}_{r l} ( x , y ) >> ( bit\_depth - {log}_{2} {N}_{b a n d} )$$

Iᵣₗ(x, y) denotes the intensity values of the reconstructed luma samples located at (x, y). bit_depth corresponds to the bit depth of the input signal, and N_{band} is the maximum allowed number of bands. The supported values of N_{band} are limited to 1, 2, 4, and 8 when BO and EO are jointly applied. When only BO is applied, the supported values of N_{band} include 1, 2, 4, 8, 16, 32, and 64. The maximum allowed number of bands is signaled at the frame-level using two or three bits.

The EO classifier takes the current luma sample (when CCSO is applied to the luma component) or the co-located luma sample (when CCSO is applied to the chroma components). The current luma sample is denoted as rl, and its neighboring samples are denoted as p0 and p1. The delta values between p0, p1 and rl are computed, denoted as m0=p0−rl and m1=p1−rl. For U and V components, rl is the co-located luma sample of rc. The delta values are further quantized, according to quantization step T, into two or three indices depending on EO quantizer types (classes). Two types of EO quantizers are supported:

$$three - interval : {EO}_{idx 0 , 1} \{ \begin{matrix}0 , & {m}_{0 , 1} < - T \\ 1 , & - T \leq {m}_{0 , 1} \leq T \\ 2 , & {m}_{0 , 1} > T\end{matrix}$$

$$two - interval : {EO}_{idx 0 , 1} = \{ \begin{matrix}0 & {m}_{0 , 1} < - T \\ 1 & {m}_{0 , 1} \geq - T\end{matrix}$$

T is denoted as quantization step with T∈{{0, 8,16, 32}, {40,56,64,128}, {24,48,96,192}, {80,112,160,256}}.

CCSO filter 406 can include seven switchable filter shapes, and only one filter shape is selected at frame-level for each color component. The selection of the filter shape is indicated by a 3-bit index. This design of filter shapes ensures that only one top and one bottom line of reconstructed samples are involved, thereby minimizing line buffer memory requirements. The seven filter shapes differ in which neighboring sample positions relative to the central luma sample are selected as p0 and p1 for computing the delta values used in EO classification. Some filter shapes use immediately adjacent horizontal, vertical, or diagonal neighbors, while other filter shapes use more distant samples along those same directions.

A combined CCSO class index CCSO_{idx}, e.g., the offset index, can be calculated using the B0 index and the EO indices as follows:

$${CCSO}_{idx} = ( {BO}_{idx} << 4 ) + ( {EO}_{idx 0} << 2 ) + {EO}_{idx 1}$$

If only BO classifier is used without EO classifier, the EO_{idx0,1} are set as zero. The CCSO_{idx} can be used as the input to the offset values LUT to derive the corresponding offset values. This LUT is adaptively generated for individual color component inside one frame at encoder 102 and signaled into the bitstream. The size of this LUT depends on the number of possible values of CCSO_{idx}.

For joint BO and EO mode, when the maximum number of bands is 8, and the maximum quantization intervals in EO is 3 intervals. The LUT size in this case equals 8×3×3=72. For the BO-only case, the largest possible LUT size is 64. The LUT entries sᵢ with i=CCSO_{idx} of this LUT directly reflect the offset values that are added on the output of the CDEF 404. The values are selected based on actual statistics and can be limited to:

$${s}_{i} ∈ \{ 0 , 1 , - 1 , 3 , - 3 , 7 , - 7 , - 10 \}$$

The CCSO mechanism in CCSO filter 406 incorporates multiple frame-level syntax elements to enable efficient filtering control. These elements define whether CCSO filter 406 is applied, how it is configured, and the relevant parameters for processing. The key syntax elements or filter parameters are listed as follows:
CCSO frame flag (1 bit): Signals whether CCSO filter 406 is applied to any color component in the current frame.
CCSO enable flag (1 bit): Specifies whether CCSO filter 406 is enabled for a particular color component within the frame.
Scale index or scale_idx (2 bit): Specifies which quant step set is selected.
CCSO reuse: Specifies whether the frame (color component) would reuse the CCSO parameters of a reference frame.
Band-only flag (1 bit): Determines if the BO classifier operates independently or in conjunction with the EO classifier.
Max band log 2 or max_band_log_2 (2 or 3 bits): Represents the base-2 logarithm of the maximum number of allowable bands, providing flexible band selection.
Quant step index or quant_step_idx (2 bits): Specifies the quantization step selection with scale index.
Filter shape index or filter_shape_idx (3 bits): Identifies the filter shape used within the EO classifier.
Edge classifier or edge_clf (1 bit): Defines the EO quantizer type, determining how edge information is processed.
Offset index or offset idx: For each CCSO class, this index specifies a LUT entry from eight predefined values).

The derivation of the above frame-level syntaxes or filter parameters involves evaluating different combinations of model parameters through cascaded loops. This approach results in substantial search computations. Therefore, significant complexity reduction is needed for the actual real-world solutions.

Encoder 102 may include CCSO filtering decision part 440 to make one or more encoding decisions, e.g., determine the above frame-level syntaxes or filter parameters for CCSO filter 406. In this case, CCSO filtering decision part 440 may make one or more CCSO filtering decisions 460. CCSO filtering decision part 440 may output one or more CCSO filtering decisions 460 to control CCSO filter 406. CCSO filtering decisions 460 may be encoded as syntax elements in the encoded bitstream.

CCSO filtering decision part 440 may receive video frames 104. CCSO filtering decision part 440 may receive frame type 490 and encoded frame size 492. CCSO filtering decision part 440 may use one or more of: video frames 104, frame type 490, and encoded frame size 492 to determine one or more filter parameters (referred to herein as one or more CCSO filtering decisions 460) for CCSO filter 406. CCSO filtering decision part 440 may perform parameter search and rate-distortion optimization (RDO) when making one or more CCSO filtering decisions 460 for controlling CCSO filter 406. RDO determines a trade-off between the bitrate (e.g., a compression rate), and the distortion (e.g., quality, objective quality, subjective quality, etc.) introduced by the compression process. The goal of RDO is to make an optimal encoding decision (in this case, one or more CCSO filtering decisions 460) that minimizes a rate-distortion cost function that balances bitrate and distortion in the following equation:

$$Cost = distortion + λ * bitrate$$

Cost represents the rate-distortion cost. distortion represents the distortion (e.g., mean squared error, sum of absolute differences, objective quality loss, subjective quality loss, etc.). bitrate represents the bitrate, or a number of bits to encode the data. λ or lambda is an RDO parameter (sometimes referred to as the Lagrangian multiplier) that can control or adjust the relative importance of bitrate versus distortion in the rate-distortion cost function. A higher value for 2 means more emphasis on reducing the bitrate. A lower value for λ means more emphasis on reducing distortion.

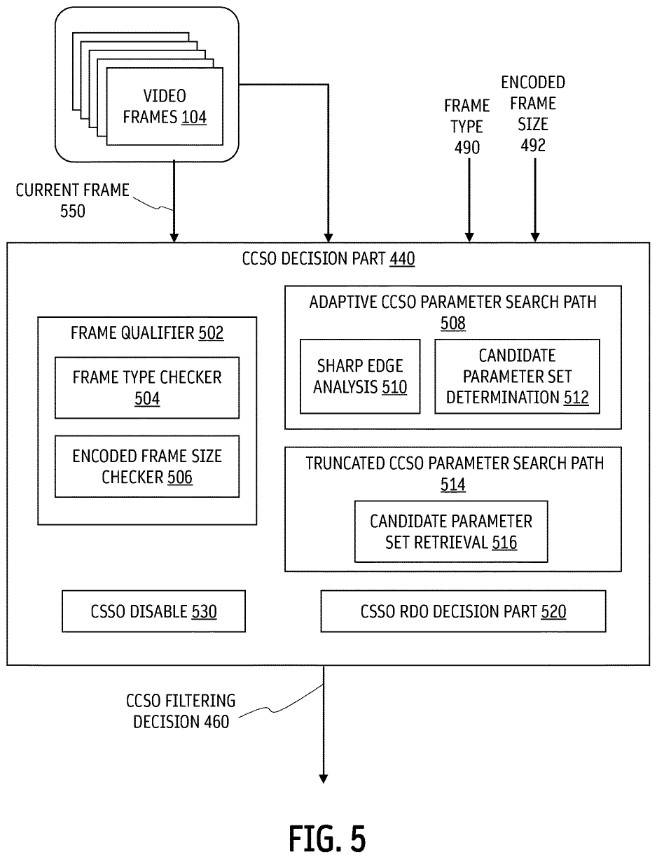

The technical challenge for CCSO filtering decision part 440 is to make one or more CCSO filtering decisions 460 efficiently without sacrificing video quality. CCSO filtering decision part 440 can address this technical challenge by implementing operations and parts as described and illustrated in FIGS. 5-8.

FIG. 5 illustrates CCSO filtering decision part 440, according to some examples of the disclosure. CCSO filtering decision part 440 receives current frame 550 from video frames 104, along with frame type 490 and encoded frame size 492 as inputs. CCSO filtering decision part 440 comprises one or more of: frame qualifier 502, adaptive CCSO parameter search path 508, truncated CCSO parameter search path 514, CCSO disable 530, and CCSO RDO decision part 520. CCSO filtering decision part 440 produces one or more CCSO filtering decisions 460 as output, which governs whether and/or how CCSO filtering is applied to current frame 550.

Frame qualifier 502 comprises frame type checker 504 and encoded frame size checker 506. Frame type checker 504 can evaluate frame type 490 to determine whether current frame 550 is an intra-frame, an anchor frame, or an inter-frame. Frame type 490 can represent the frame type of current frame 550. Current frame 550 can be associated with one or more frame types, such as intra-frame or I-frame, inter-frame or B-frame, and anchor frame.

In a hierarchical random-access coding structure such as GOP8, or GOP16, frames are organized into intra-frames (I-frames), which are encoded without reference to any other frame and serve as independent decoding entry points. Anchor frames are the inter-frames encoded at the lowest quantization parameter within each GOP and serve as the primary temporal reference points for all other inter-frames in the group. Remaining inter-frames are organized into hierarchical layers, where each layer references frames from the layer immediately below it, with each successive layer representing a finer temporal subdivision of the GOP. Frame layer determines encoding priority and quality allocation, with lower-layer frames receiving more bits and higher-layer frames encoded at progressively higher quantization parameters.

Frame type checker 504 can route current frame 550 to adaptive CCSO parameter search path 508 when current frame 550 is an intra-frame or an anchor frame.

Frame type checker 504 can route current frame 550 to encoded frame size checker 506 when current frame 550 is an inter-frame. Encoded frame size checker 506 can evaluate encoded frame size 492 of a lower-layer reference frame associated with current frame 550 against one or more thresholds to determine which path of one or more of: adaptive CCSO parameter search path 508, truncated CCSO parameter search path 514, or CCSO disable 530 is selected for inter-frames.

In some examples, frame qualifier 502 may implement a hierarchical decision such that frame type checker 504 is evaluated first, and encoded frame size checker 506 is evaluated only when current frame 550 is an inter-frame that is not an anchor frame.

In some examples, encoded frame size checker 506 may compare encoded frame size 492 against a first threshold and a second threshold defining three non-overlapping ranges, each range corresponding to one of the three possible paths within CCSO filtering decision part 440. In some cases, encoded frame size checker 506 may compare encoded frame size 492 against a different number of thresholds defining a different number of non-overlapping ranges, each range corresponding to a possible path within CCSO filtering decision part 440.

Adaptive CCSO parameter search path 508 comprises sharp edge analysis 510 and candidate parameter set determination 512. Sharp edge analysis 510 can compute a sharpness metric for current frame 550 by measuring a percentage or proportion of blocks having a block variance exceeding a threshold. Candidate parameter set determination 512 can use the sharpness metric produced by sharp edge analysis 510 to select a reduced subset of CCSO filter parameter candidates, comprising one or more of: a subset of supported scale indices, a subset of supported quantization steps, and a subset of supported filter shapes.

Candidate parameter set determination 512 can use the sharpness metric produced by sharp edge analysis 510 to select a subset (e.g., 1~2) of candidates from 4 scale indexes. Candidate parameter set determination 512 can use the sharpness metric produced by sharp edge analysis 510 to select a subset (e.g., 2~4) of candidates from 4 quantizer steps. Candidate parameter set determination 512 can use the sharpness metric produced by sharp edge analysis 510 to select a subset (e.g., 4) of candidates from 7 filter shapes. Candidate parameter set determination 512 can use the sharpness metric produced by sharp edge analysis 510 to select a subset (e.g., 1) of candidates from 2 EO quantizer types. Candidate parameter set determination 512 can use the sharpness metric produced by sharp edge analysis 510 to select a subset (e.g., 1~2) of candidates from 7 band candidates. During the CCSO parameter search process, only the selected subsets are processed instead of all the possible combinations.

In some examples, candidate parameter set determination 512 may restrict edge-offset quantizer types to a three-interval quantizer only, excluding two-interval quantizer candidates from evaluation.

In some examples, candidate parameter set determination 512 may further restrict band count candidates to a subset based on whether a band-offset classifier and an edge-offset classifier are used jointly or whether only the band-offset classifier is used, with the subset for luma comprising a greater maximum band count than the subset for chroma.

In some examples, candidate parameter set determination 512 may skip evaluation of a band-offset only mode entirely when current frame 550 is an intra-frame or an anchor frame.

Truncated CCSO parameter search path 514 comprises candidate parameter set retrieval 516. Candidate parameter set retrieval 516 can determine CCSO filter parameter candidates by retrieving parameter sets previously derived for one or more reference frames of current frame 550, without performing a new parameter search. In some examples, truncated CCSO parameter search path 514 may be selected when encoded frame size 492 falls within a range indicating moderate scene complexity, such that reusing reference frame parameter sets provides sufficient rate-distortion performance at substantially reduced computational cost.

CCSO disable 530 can set one or more CCSO filtering decisions 460 to disable CCSO filtering for current frame 550 without evaluating any parameter candidates. In some examples, CCSO disable 530 may be selected when encoded frame size 492 falls within a range indicating low scene complexity, such that the quality benefit of CCSO filtering does not justify the associated signaling and search overhead.

CCSO RDO decision part 520 can receive candidate parameter sets from adaptive CCSO parameter search path 508 or truncated CCSO parameter search path 514 and evaluate each candidate based on an associated rate-distortion cost. CCSO RDO decision part 520 can select the candidate parameter set yielding the lowest rate-distortion cost and produce one or more CCSO filtering decisions 460 accordingly.

In some examples, one or more CCSO filtering decisions 460 may be signaled in an output bitstream as one or more CCSO frame-level syntax elements, enabling detection of the selected parameter subset in encoded video bitstreams.

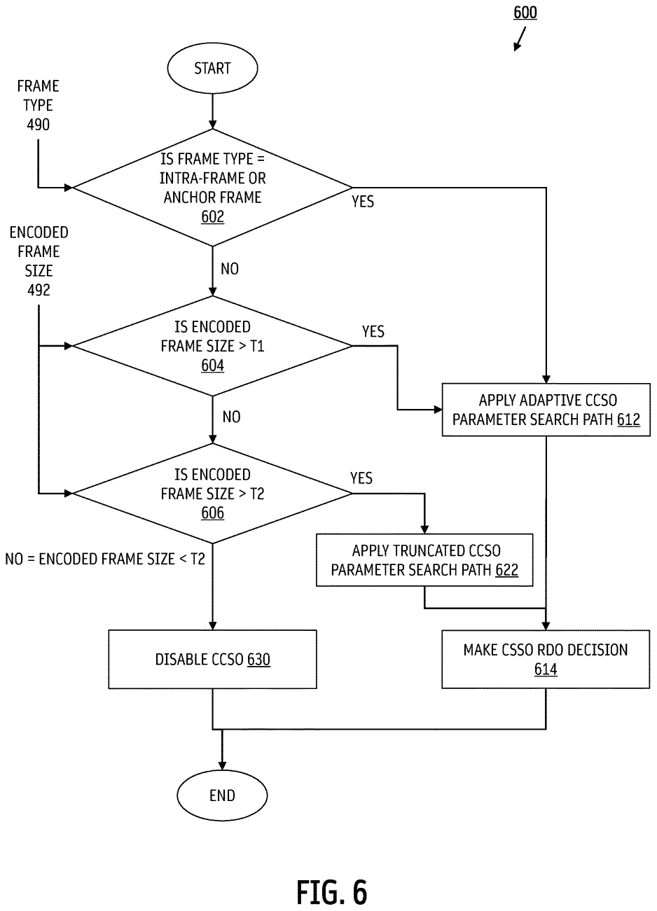

FIG. 6 illustrates CCSO filtering decision process 600, according to some examples of the disclosure. CCSO filtering decision process 600 can be carried out in CCSO filtering decision part 440 of encoder 102 as described and illustrated in FIGS. 4-5.

In 602, the encoder evaluates frame type 490 to determine whether current frame 550 is an intra-frame or an anchor frame. Performing this evaluation can include identifying whether the current frame is coded without reference to any other frame, or whether it is the lowest-quantization-parameter inter-frame within the current group-of-pictures.

When the result of 602 is YES, CCSO filtering decision part 440 proceeds to 612 (apply adaptive CCSO parameter search path), because intra-frames and anchor frames are the important frames in the hierarchical structure and their CCSO parameters propagate quality benefits to all dependent frames, justifying the higher search cost.

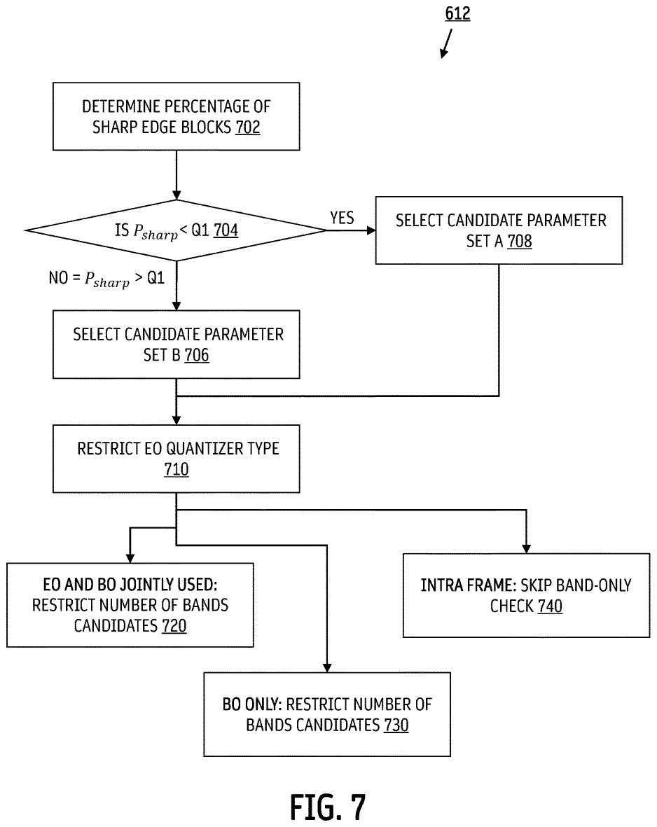

In 612, CCSO filtering decision part 440 may perform operations described and illustrated in FIG. 7.

When the result of 602 is NO, CCSO filtering decision part 440 proceeds to 604 and evaluates whether encoded frame size 492 of a lower-layer reference frame exceeds first threshold T1.

When the result of 604 is YES, CCSO filtering decision part 440 proceeds to 612 (apply adaptive CCSO parameter search path). Performing this evaluation can include retrieving the encoded bitstream size of the most recently encoded frame at the immediately lower hierarchical layer relative to the current frame. For example, if the current frame is a B-frame, the previous encoded B0 frame size is checked. If the current frame is B1, the previous encoded B-frame size is checked. If the current frame is B2, the previous encoded B1 frame size is checked. A large encoded frame size 492 (e.g., where the result of 604 is YES) indicates high scene complexity or significant residual content, signaling that CCSO filtering is likely to yield meaningful quality improvement and that an adaptive CCSO parameter search with higher search cost is warranted.

When the result of 604 is NO, CCSO filtering decision part 440 proceeds to 606 and evaluates whether encoded frame size 492 exceeds second threshold T2, where T2 is less than T1. Performing this evaluation partitions the remaining inter-frames into two further categories based on moderate versus low scene complexity.

In some examples, T1 and T2 together define three non-overlapping ranges of encoded frame size 492, each range deterministically selecting one of the three possible downstream paths (e.g., 612, 622, or 630). In some examples, the multi-threshold decision structure of CCSO filtering decision process 600 ensures that computational resources are concentrated on frames where CCSO filtering provides the greatest rate-distortion benefit, while low-complexity frames are processed with minimal overhead. In some examples, T1 may be calibrated such that frames associated with high-motion or high-detail content are reliably routed to 612 (apply adaptive CCSO parameter search path), ensuring that quality-critical inter-frames receive a thorough, content-adaptive parameter search. In some examples, T2 may be calibrated such that frames associated with moderate-motion or moderate-detail content are reliably routed to 622 (apply truncated CCSO parameter search path), ensuring that quality-critical inter-frames receive a thorough, content-adaptive parameter search.

When the result of 606 is YES, CCSO filtering decision part 440 proceeds to 622 (apply truncated CCSO parameter search path).

In 622, CCSO filtering decision part 440 can apply a truncated CCSO parameter search path. Applying the truncated CCSO parameter search path can include retrieving CCSO filter parameter candidates that were previously derived for one or more reference frames of the current frame, and evaluating those candidates based on their associated rate-distortion costs, without generating any new parameter candidates. In some examples, this truncated path exploits temporal correlation between adjacent frames in the hierarchical structure, recognizing that for moderately complex inter-frames the parameter sets of reference frames are likely to remain competitive, thereby avoiding redundant search computation.

When the result of 606 is NO, indicating that encoded frame size 492 is less than T2, CCSO filtering decision part 440 proceeds to 630 (disable CCSO).

In 630, CCSO filtering decision part 440 can set the CCSO filtering decision to disable CCSO for the current frame entirely, bypassing both parameter search paths and suppressing CCSO syntax element signaling for the frame. In some examples, the disabling path is selected when the reference frame size indicates sufficiently low scene complexity that CCSO filtering would yield negligible quality benefit, making the search and signaling overhead unjustifiable.

In 614, CCSO filtering decision part 440 performs RDO based on outputs from either 612 (adaptive CCSO parameter search path) or 622 (truncated CCSO parameter search path). Making CCSO RDO decisions can include evaluating each candidate parameter set based on its associated rate-distortion cost and selecting the parameter set that minimizes the cost. In some examples, CCSO filtering decision part 440 produces one or more CCSO filtering decisions, which encode the selected CCSO filter parameters into the output bitstream as frame-level syntax elements.

In some examples, CCSO filtering decision process 600 may be applied independently per color channel within a frame, such that different channels may follow different paths through the decision tree based on their respective encoded frame sizes and sharpness characteristics.

FIG. 7 illustrates an adaptive CCSO parameter search path as performed in 612 of FIG. 6, according to some examples of the disclosure. 612 can be carried out in CCSO filtering decision part 440 of encoder 102 as described and illustrated in FIGS. 4-5.

In 702, CCSO filtering decision part 440 determines a percentage or proportion of sharp edge blocks Pₛₕₐᵣₚ for the current frame. Determining a percentage of sharp edge blocks can include computing the variance of each block across the current frame and comparing each block variance against a sharpness threshold, such that Pₛₕₐᵣₚ represents the proportion of blocks whose variance exceeds the threshold. In some examples, determining a percentage of sharp edge blocks involves operating on reconstructed luma samples of the current frame, as luma variance is a reliable proxy for the presence of sharp transitions in content such as text, object boundaries, or high-contrast scene elements.

The sharpness metric Pₛₕₐᵣₚ may be computed using any of a variety of content analysis techniques applied to reconstructed samples of the current frame. In one implementation, Pₛₕₐᵣₚ is derived as the percentage or proportion of blocks whose pixel variance exceeds a threshold, such that blocks exhibiting high variance are classified as sharp edge blocks. In other implementations, Pₛₕₐᵣₚ may be computed using gradient-based measures, such as a Sobel, Prewitt, or Laplacian operator applied to reconstructed luma samples, wherein blocks having a mean gradient magnitude exceeding a threshold are classified as sharp. In yet other implementations, Pₛₕₐᵣₚ may be derived from edge detection outputs, such as a Canny edge detector, wherein the density of detected edge pixels within each block determines whether the block is classified as sharp. In still other implementations, Pₛₕₐᵣₚ may be approximated using coding statistics already available to the encoder, such as the sum of absolute differences (SAD), sum of absolute transformed differences (SATD), or residual energy associated with each block, avoiding the need for additional pixel-domain analysis. In some implementations, Pₛₕₐᵣₚ may be computed on a sub-sampled or downscaled representation of the frame to reduce computational overhead, or may reuse luma sample statistics derived during earlier stages of the encoding pipeline, such as during mode decision or motion estimation. Regardless of the specific computation, Pₛₕₐᵣₚ serves as a content-adaptive scalar metric that steers the selection of CCSO filter parameter candidates, and a measure that reliably distinguishes blocks containing sharp luminance transitions from blocks containing smooth or gradually varying content may be used to derive Pₛₕₐᵣₚ.

In 704, CCSO filtering decision part 440 evaluates whether Pₛₕₐᵣₚ is less than sharpness threshold Q1. The evaluation in 704 can include comparing the derived percentage of sharp edge blocks Pₛₕₐᵣₚ against Q1 to determine whether the current frame is predominantly smooth or predominantly sharp in character. In some examples, the check in 704 routes smooth frames, e.g., where most blocks exhibit low variance, toward 708 (select candidate parameter set A), and routes sharp frames toward 706 (select candidate parameter set B), reflecting that the optimal CCSO filter parameter subset differs materially between smooth and sharp content.

When the result of 704 is YES, indicating Pₛₕₐᵣₚ is less than Q1 (e.g., the frame has relatively smooth content), CCSO filtering decision part 440 proceeds to 708 (select candidate parameter set A). In 708, selecting candidate parameter set A can include one or more of: restricting the scale index to scale_idx=1 only, corresponding to smaller quantization steps T∈{0, 8, 16, 32}, and selecting filter shape indices 0, 1, 5, and 6, which use more distant neighboring samples relative to the central luma sample. In some examples, selecting candidate parameter set A reflects the insight that for smooth content, small quantization steps provide finer EO classification among subtly varying regions, and distant neighbors capture the gradual intensity transitions characteristic of smooth areas more effectively than immediate neighbors.

When the result of 704 is NO, indicating Pₛₕₐᵣₚ is greater than Q1 (e.g., the frame has relatively sharp content), CCSO filtering decision part 440 proceeds to 706 (select candidate parameter set B). In 706, selecting candidate parameter set B can include one or more of: restricting the scale index to scale_idx=1 and scale_idx=2, corresponding to quantization steps T∈{0, 8, 16, 32} and T∈{40, 56, 64, 128} respectively, and selecting filter shape indices 0, 1, 2, and 3, which use nearer neighboring samples relative to the central luma sample. In some examples, selecting candidate parameter set B reflects the insight that for sharp content, larger quantization steps are needed to meaningfully separate the EO class of sharp edge pixels from surrounding non-edge pixels, and immediate neighbors carry the most discriminative information about localized, high-contrast transitions.

Following selection of either 708 or 706, CCSO filtering decision part 440 proceeds to 710 (restrict EO quantizer type). Performing restrict EO quantizer type can include limiting the edge-offset quantizer type candidates exclusively to the three-interval EO quantizer, excluding the two-interval EO quantizer from evaluation entirely. In some examples, 710 is applied uniformly regardless of the sharpness branch taken, because empirical analysis demonstrated that the three-interval quantizer yields equal or superior rate-distortion performance for a large majority of content, making the additional complexity of evaluating the two-interval quantizer unjustifiable. In some examples, 710 is optional.

Following 710, CCSO filtering decision part 440 may proceed to 720. In 720, based on jointly EO and BO being used and evaluated, CCSO filtering decision part 440 may restrict the number of band candidates being evaluated. Restricting the number of band candidates in the joint EO and BO case can include limiting the band count candidates to a maximum band count for luma and a maximum band count for chroma. In some examples, the maximum band count for luma is greater than the maximum band count for chroma. In some examples, performing this restriction limits luma band candidates to max_band_log_2=6, corresponding to 64 bands, and chroma band candidates to max_band_log_2=4, corresponding to 16 bands, reflecting that chroma channels exhibit substantially less intensity variation than luma and therefore require fewer bands to achieve adequate classification. In some examples, 720 is optional.

Following 710, CCSO filtering decision part 440 may proceed to 730. In 730, based on only B0 being used and evaluated (e.g., where only the band-offset classifier is used), CCSO filtering decision part 440 may restrict the number of bands candidates being evaluated. Restricting the number of bands in the BO-only case can include limiting luma band count candidates to max_band_log_2=6 and max_band_log_2=5, corresponding to 64 and 32 bands, respectively, and limiting chroma band count candidates to max_band_log_2=5 and max_band_log_2=4, corresponding to 32 and 16 bands, respectively. In some examples, performing this restriction reflects the principle that a single band provides no meaningful classification, e.g., assigning a uniform offset across the entire frame, and that quality gains from BO-only mode are concentrated at higher band counts, making it unnecessary or inefficient to evaluate lower band count candidates. In some examples, 730 is optional.

Following 710, CCSO filtering decision part 440 may proceed to 740. In 740, based on the current frame being an intra-frame or anchor frame, CCSO filtering decision part 440 may skip the band-only check or evaluation. Skipping the band-only check can include suppressing evaluation of the band-offset only mode entirely, such that only the joint EO and BO configuration is considered for intra-frames and anchor frames. In some examples, skipping the band-only check in this manner reflects the empirical observation that the band-offset only mode is virtually never selected as the rate-distortion optimal configuration for intra-frames or anchor frames, making its evaluation an unnecessary computational expense within the adaptive search path. In some examples, 740 is optional.

In some examples, CCSO filtering decision part 440 may apply one or more restrictions of illustrated in 612 independently per color channel within a frame, allowing luma and chroma components to follow different band count restriction paths based on their respective classification characteristics. In some examples, the parameter subsets selected by candidate parameter set A in 708 or candidate parameter set B in 706, together with the restrictions imposed by restricting EO quantizer type in 710 and the band count restrictions of 706, collectively define the candidate parameter sets forwarded to CCSO RDO decision part 520 of FIG. 5 for final rate-distortion optimization and selection.

### Example Methods for Encoding a Video

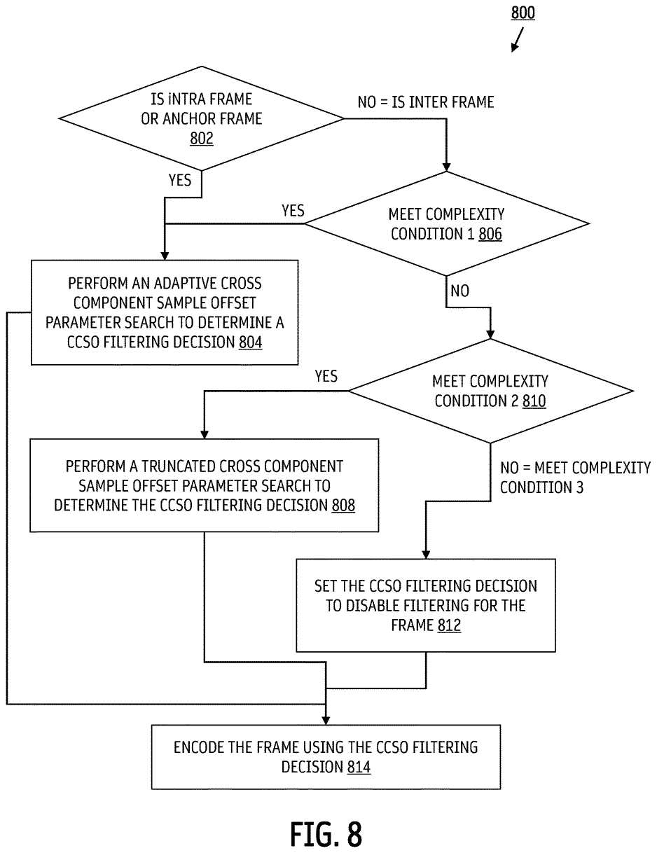

FIG. 8 illustrates method 800 for encoding a video, according to some examples of the disclosure. Method 800 can be carried out in CCSO filtering decision part 440 of encoder 102 as described and illustrated in FIGS. 4-5.

In 804, based on a frame type of a frame of a video being an intra-frame or an anchor frame (YES determined in 802), an adaptive CCSO search is performed to determine a CCSO filtering decision. Moreover, based on the frame type being an inter-frame (NO determined in 802), the adaptive CCSO parameter search is performed in 804 to determine the CCSO filtering decision based on the frame meeting a complexity condition (YES determined in 806).

In 808, a truncated CCSO parameter search is performed to determine the CCSO filtering decision based on the frame meeting a further complexity condition (YES determined in 810).

In 812, the CCSO filtering decision is set to disable filtering for the frame based on the frame meeting a yet further complexity condition (NO determined in 810).

In 814, the frame is encoded using the CCSO filtering decision.

In some examples, performing the adaptive CCSO parameter search in 804 to determine the CCSO filtering decision comprises: selecting one or more CCSO filter parameter candidates based on a sharpness metric of the frame, and evaluating the one or more CCSO filter parameter candidates based on one or more rate-distortion costs associated with the one or more CCSO filter parameters.

In some examples, the sharpness metric measures a percentage or proportion of blocks of the frame having a block variance exceeding a threshold.

In some examples, selecting one or more CCSO filter parameter candidates comprises selecting one or more of: a subset of supported scale indices, a subset of supported quantization steps, and a subset of supported filter shapes.

In some examples, meeting the complexity condition in 806 comprises an encoded frame size of a lower-layer frame of the frame being within a range, meeting the further complexity condition in 810 comprises the encoded frame size being within a further range, and meeting a yet further complexity condition in 810 comprises the encoded frame size being within a yet further range. The range, the further range, and the yet further range are non-overlapping.

In some examples, performing the adaptive CCSO parameter search in 804 to determine the CCSO filtering decision comprises: reducing edge-offset quantizer types to a subset of the edge-offset quantizer types, and evaluating the subset of the edge-offset quantizer types based on one or more rate-distortion costs associated with the subset.

In some examples, performing the adaptive CCSO parameter search in 804 to determine the CCSO filtering decision comprises: reducing band counts to a subset of the band counts based on a band-offset classifier and an edge-offset classifier being jointly used for the frame, and evaluating the subset of the band counts based on one or more rate-distortion costs associated with the subset.

In some examples, the subset of the band counts comprises a maximum band count for luma and a maximum band count for chroma, and the maximum band count for luma is greater than the maximum band count for chroma.

In some examples, performing the adaptive CCSO parameter search in 804 to determine the CCSO filtering decision comprises: reducing band counts to a subset of the band counts based on only the band-offset classifier being used for the frame, and evaluating the subset of the band counts based on one or more rate-distortion costs associated with the subset.

In some examples, performing the adaptive CCSO parameter search in 804 to determine the CCSO filtering decision comprises: skipping evaluation of a band-offset only mode based on the frame being the intra-frame or the anchor frame.

In some examples, performing the truncated CCSO parameter search in 808 to determine the CCSO filtering decision comprises: determining one or more CCSO filter parameter candidates used for one or more reference frames of the frame, evaluating the one or more CCSO filter parameter candidates based on one or more rate-distortion costs associated with the one or more CCSO filter parameters.

### Exemplary Computing Device

FIG. 9 is a block diagram of an apparatus or a system, e.g., an exemplary computing device 900, according to some examples of the disclosure. One or more computing devices 900 may be used to implement the functionalities described with the FIGS. and herein. A number of components are illustrated in FIG. 9 that can be included in computing device 900, but any one or more of these components may be omitted or duplicated, as suitable for the application. In some examples, some or all of the components included in computing device 900 may be attached to one or more motherboards. In some examples, some or all of these components are fabricated onto a single system on a chip (SoC) die. Additionally, in various examples, computing device 900 may not include one or more of the components illustrated in FIG. 9, and computing device 900 may include interface circuitry for coupling to the one or more components. For example, computing device 900 may not include a display device 906, and may include display device interface circuitry (e.g., a connector and driver circuitry) to which a display device 906 may be coupled. In another set of examples, computing device 900 may not include audio input device 918 or audio output device 908 and may include audio input or output device interface circuitry (e.g., connectors and supporting circuitry) to which an audio input device 918 or audio output device 908 may be coupled.

Computing device 900 may include a processing device 902 (e.g., one or more processing devices, one or more of the same type of processing device, one or more of different types of processing devices). The processing device 902 may include processing circuitry or electronic circuitry that process electronic data from data storage elements (e.g., registers, memory, resistors, capacitors, quantum bit cells) to transform that electronic data into other electronic data that may be stored in registers and/or memory. Examples of processing device 902 may include a CPU, a GPU, a quantum processor, a machine learning processor, an artificial intelligence processor, a neural-network processor, an artificial intelligence accelerator, an application-specific integrated circuit (ASIC), an analog signal processor, an analog computer, a microprocessor, a digital signal processor, a field-programmable gate array (FPGA), a tensor processing unit (TPU), a data processing unit (DPU), etc.

Computing device 900 may include a memory 904, which may itself include one or more memory devices such as volatile memory (e.g., DRAM), nonvolatile memory (e.g., read-only memory (ROM)), high-bandwidth memory (HBM), flash memory, solid-state memory, and/or a hard drive. Memory 904 includes one or more non-transitory computer-readable storage media. In some examples, memory 904 may include memory that shares a die with the processing device 902.

In some examples, memory 904 includes one or more non-transitory computer-readable media storing instructions executable to perform operations described herein, such as operations illustrated in FIGS. 1-8, CCSO filtering decision process 600, and method 800. In some examples, memory 904 includes one or more non-transitory computer-readable media storing instructions executable to perform one or more operations of encoder 102. In some examples, memory 904 includes one or more non-transitory computer-readable media storing instructions executable to perform one or more operations of CCSO filtering decision part 440. In some examples, memory 904 includes one or more non-transitory computer-readable media storing instructions executable to perform one or more operations of in-loop filter 228. The instructions stored in memory 904 may be executed by processing device 902.

In some examples, memory 904 may store data, e.g., data structures, binary data, bits, metadata, files, blobs, etc., as described with the FIGS. and herein. Memory 904 may include one or more non-transitory computer-readable media storing one or more of: input frames to the encoder (e.g., video frames 104), intermediate data structures computed by the encoder, bitstream generated by the encoder (encoded bitstream 180), bitstream received by a decoder (encoded bitstream 180), intermediate data structures computed by the decoder, and reconstructed frames generated by the decoder. Memory 904 may include one or more non-transitory computer-readable media storing one or more of: data received and/or data generated by CCSO filtering decision process 600 of FIGS. 6-7. Memory 904 may include one or more non-transitory computer-readable media storing one or more of: data received and/or data generated by method 800 of FIG. 8. Memory 904 may include decoded picture buffer 232.

In some examples, computing device 900 may include a communication device 912 (e.g., one or more communication devices). For example, communication device 912 may be configured for managing wired and/or wireless communications for the transfer of data to and from computing device 900. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some examples they might not. Communication device 912 may implement any of a number of wireless standards or protocols. Communication device 912 may operate in accordance with other wireless protocols in other examples. Computing device 900 may include an antenna 922 to facilitate wireless communications and/or to receive other wireless communications (such as radio frequency transmissions). Computing device 900 may include receiver circuits and/or transmitter circuits. In some examples, communication device 912 may manage wired communications, such as electrical, optical, or any other suitable communication protocols (e.g., the Ethernet). As noted above, communication device 912 may include multiple communication chips. For instance, a first communication device 912 may be dedicated to shorter-range wireless communications such as Wi-Fi or Bluetooth, and a second communication device 912 may be dedicated to longer-range wireless communications. In some examples, a first communication device 912 may be dedicated to wireless communications, and a second communication device 912 may be dedicated to wired communications.

Computing device 900 may include power source/power circuitry 914. Power source/power circuitry 914 may include one or more energy storage devices (e.g., batteries or capacitors) and/or circuitry for coupling components of computing device 900 to an energy source separate from computing device 900 (e.g., DC power, AC power, etc.).

Computing device 900 may include display device 906 (or corresponding interface circuitry, as discussed above). Display device 906 may include any visual indicators, such as a heads-up display, a computer monitor, a projector, a touchscreen display, a liquid crystal display (LCD), a light-emitting diode display, or a flat panel display, for example.

Computing device 900 may include audio output device 908 (or corresponding interface circuitry, as discussed above). Audio output device 908 may include any device that generates an audible indicator, such as speakers, headsets, or earbuds, for example.

Computing device 900 may include audio input device 918 (or corresponding interface circuitry, as discussed above). Audio input device 918 may include any device that generates a signal representative of a sound, such as microphones, microphone arrays, or digital instruments (e.g., instruments having a musical instrument digital interface (MIDI) output).

Computing device 900 may include global positioning system (GPS) device 916 (or corresponding interface circuitry, as discussed above). GPS device 916 may be in communication with a satellite-based system and may receive a location of computing device 900, as known in the art.

Computing device 900 may include sensor 930 (or one or more sensors). Computing device 900 may include corresponding interface circuitry, as discussed above). Sensor 930 may sense physical phenomena and translate the physical phenomena into electrical signals that can be processed by, e.g., processing device 902. Examples of sensor 930 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 900 may include another output device 910 (or corresponding interface circuitry, as discussed above). Examples of the other output device 910 may include an audio codec, a video codec, a printer, a wired or wireless transmitter for providing information to other devices, haptic output device, gas output device, vibrational output device, lighting output device, home automation controller, or an additional storage device.

Computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 900 may have any desired form factor, such as a handheld or mobile computer system (e.g., a cell phone, a smartphone, a mobile Internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some examples, computing device 900 may be any other electronic device that processes data.

### SELECT EXAMPLES

Example 1 provides one or more non-transitory computer-readable media storing instructions that, when executed by one or more processors, cause the one or more processors to: based on a frame type of a frame of a video being an intra-frame or an anchor frame, perform an adaptive cross-component sample offset (CCSO) search to determine a CCSO filtering decision; based on the frame type being an inter-frame: perform the adaptive CCSO parameter search to determine the CCSO filtering decision based on the frame meeting a complexity condition; perform a truncated CCSO parameter search to determine the CCSO filtering decision based on the frame meeting a further complexity condition; and set the CCSO filtering decision to disable filtering for the frame based on the frame meeting a yet further complexity condition; and encode the frame using the CCSO filtering decision.

Example 2 provides the one or more non-transitory computer-readable media of example 1, where performing the adaptive CCSO parameter search to determine the CCSO filtering decision includes selecting one or more CCSO filter parameter candidates based on a sharpness metric of the frame; and evaluating the one or more CCSO filter parameter candidates based on one or more rate-distortion costs associated with the one or more CCSO filter parameter candidates.

Example 3 provides the one or more non-transitory computer-readable media of example 2, where the sharpness metric measures a percentage or proportion of blocks of the frame having a block variance exceeding a threshold.

Example 4 provides the one or more non-transitory computer-readable media of example 2 or 3, where selecting the one or more CCSO filter parameter candidates includes selecting one or more of: a subset of supported scale indices, a subset of supported quantization steps, and a subset of supported filter shapes.

Example 5 provides the one or more non-transitory computer-readable media of any one of examples 1-4, where: meeting the complexity condition includes an encoded frame size of a lower-layer frame of the frame being within a range; meeting the further complexity condition includes the encoded frame size being within a further range; and meeting a yet further complexity condition includes the encoded frame size being within a yet further range; where the range, the further range, and the yet further range are non-overlapping.

Example 6 provides the one or more non-transitory computer-readable media of any one of examples 1-5, where performing the adaptive CCSO parameter search to determine the CCSO filtering decision includes reducing edge-offset quantizer types to a subset of the edge-offset quantizer types; and evaluating the subset of the edge-offset quantizer types based on one or more rate-distortion costs associated with the subset.

Example 7 provides the one or more non-transitory computer-readable media of any one of examples 1-6, where performing the adaptive CCSO parameter search to determine the CCSO filtering decision includes reducing band counts to a subset of the band counts based on a band-offset classifier and an edge-offset classifier being jointly used for the frame; and evaluating the subset of the band counts based on one or more rate-distortion costs associated with the subset.

Example 8 provides the one or more non-transitory computer-readable media of example 7, where: the subset of the band counts includes a maximum band count for luma and a maximum band count for chroma; and the maximum band count for luma is greater than the maximum band count for chroma.

Example 9 provides the one or more non-transitory computer-readable media of any one of examples 1-8, where performing the adaptive CCSO parameter search to determine the CCSO filtering decision includes reducing band counts to a subset of the band counts based on only a band-offset classifier being used for the frame; and evaluating the subset of the band counts based on one or more rate-distortion costs associated with the subset.

Example 10 provides the one or more non-transitory computer-readable media of any one of examples 1-9, where performing the adaptive CCSO parameter search to determine the CCSO filtering decision includes skipping evaluation of a band-offset only mode based on the frame being the intra-frame or the anchor frame.

Example 11 provides the one or more non-transitory computer-readable media of any one of examples 1-10, where performing the truncated CCSO parameter search to determine the CCSO filtering decision includes determining one or more CCSO filter parameter candidates used for one or more reference frames of the frame; and evaluating the one or more CCSO filter parameter candidates based on one or more rate-distortion costs associated with the one or more CCSO filter parameter candidates.

Example 12 provides an apparatus, including one or more processors; and one or more non-transitory computer-readable media storing instructions that, when executed by the one or more processors, cause the one or more processors to: based on a frame type of a frame of a video being an intra-frame or an anchor frame, perform an adaptive cross-component sample offset (CCSO) search to determine a CCSO filtering decision; based on the frame type being an inter-frame: perform the adaptive CCSO parameter search to determine the CCSO filtering decision based on the frame meeting a complexity condition; perform a truncated CCSO parameter search to determine the CCSO filtering decision based on the frame meeting a further complexity condition; and set the CCSO filtering decision to disable filtering for the frame based on the frame meeting a yet further complexity condition; and encode the frame using the CCSO filtering decision.

Example 13 provides the apparatus of example 12, where performing the adaptive CCSO parameter search to determine the CCSO filtering decision includes selecting one or more CCSO filter parameter candidates based on a sharpness metric of the frame; and evaluating the one or more CCSO filter parameter candidates based on one or more rate-distortion costs associated with the one or more CCSO filter parameter candidates.

Example 14 provides the apparatus of example 13, where the sharpness metric measures a percentage or proportion of blocks of the frame having a block variance exceeding a threshold.

Example 15 provides the apparatus of example 13 or 14, where selecting the one or more CCSO filter parameter candidates includes selecting one or more of: a subset of supported scale indices, a subset of supported quantization steps, and a subset of supported filter shapes.

Example 16 provides the apparatus of any one of examples 12-15, where: meeting the complexity condition includes an encoded frame size of a lower-layer frame of the frame being within a range; meeting the further complexity condition includes the encoded frame size being within a further range; and meeting a yet further complexity condition includes the encoded frame size being within a yet further range; where the range, the further range, and the yet further range are non-overlapping.

Example 17 provides the apparatus of any one of examples 12-16, where performing the adaptive CCSO parameter search to determine the CCSO filtering decision includes reducing edge-offset quantizer types to a subset of the edge-offset quantizer types; and evaluating the subset of the edge-offset quantizer types based on one or more rate-distortion costs associated with the subset.

Example 18 provides the apparatus of any one of examples 12-17, where performing the adaptive CCSO parameter search to determine the CCSO filtering decision includes reducing band counts to a subset of the band counts based on a band-offset classifier and an edge-offset classifier being jointly used for the frame; and evaluating the subset of the band counts based on one or more rate-distortion costs associated with the subset.

Example 19 provides the apparatus of example 18, where: the subset of the band counts includes a maximum band count for luma and a maximum band count for chroma; and the maximum band count for luma is greater than the maximum band count for chroma.

Example 20 provides the apparatus of any one of examples 12-19, where performing the adaptive CCSO parameter search to determine the CCSO filtering decision includes reducing band counts to a subset of the band counts based on only a band-offset classifier being used for the frame; and evaluating the subset of the band counts based on one or more rate-distortion costs associated with the subset.

Example 21 provides the apparatus of any one of examples 12-20, where performing the adaptive CCSO parameter search to determine the CCSO filtering decision includes skipping evaluation of a band-offset only mode based on the frame being the intra-frame or the anchor frame.

Example 22 provides the apparatus of any one of examples 12-21, where performing the truncated CCSO parameter search to determine the CCSO filtering decision includes determining one or more CCSO filter parameter candidates used for one or more reference frames of the frame; and evaluating the one or more CCSO filter parameter candidates based on one or more rate-distortion costs associated with the one or more CCSO filter parameter candidates.

Example 23 provides a method, including based on a frame type of a frame of a video being an intra-frame or an anchor frame, performing an adaptive cross-component sample offset (CCSO) search to determine a CCSO filtering decision; based on the frame type being an inter-frame: performing the adaptive CCSO parameter search to determine the CCSO filtering decision based on the frame meeting a complexity condition; performing a truncated CCSO parameter search to determine the CCSO filtering decision based on the frame meeting a further complexity condition; and setting the CCSO filtering decision to disable filtering for the frame based on the frame meeting a yet further complexity condition; and encoding the frame using the CCSO filtering decision.

Example 24 provides the method of example 23, where performing the adaptive CCSO parameter search to determine the CCSO filtering decision includes selecting one or more CCSO filter parameter candidates based on a sharpness metric of the frame; and evaluating the one or more CCSO filter parameter candidates based on one or more rate-distortion costs associated with the one or more CCSO filter parameter candidates.

Example 25 provides the method of example 24, where the sharpness metric measures a percentage or proportion of blocks of the frame having a block variance exceeding a threshold.

Example 26 provides the method of example 24 or 25, where selecting the one or more CCSO filter parameter candidates includes selecting one or more of: a subset of supported scale indices, a subset of supported quantization steps, and a subset of supported filter shapes.

Example 27 provides the method of any one of examples 23-26, where: meeting the complexity condition includes an encoded frame size of a lower-layer frame of the frame being within a range; meeting the further complexity condition includes the encoded frame size being within a further range; and meeting a yet further complexity condition includes the encoded frame size being within a yet further range; where the range, the further range, and the yet further range are non-overlapping.

Example 28 provides the method of any one of examples 23-27, where performing the adaptive CCSO parameter search to determine the CCSO filtering decision includes reducing edge-offset quantizer types to a subset of the edge-offset quantizer types; and evaluating the subset of the edge-offset quantizer types based on one or more rate-distortion costs associated with the subset.

Example 29 provides the method of any one of examples 23-28, where performing the adaptive CCSO parameter search to determine the CCSO filtering decision includes reducing band counts to a subset of the band counts based on a band-offset classifier and an edge-offset classifier being jointly used for the frame; and evaluating the subset of the band counts based on one or more rate-distortion costs associated with the subset.

Example 30 provides the method of example 29, where: the subset of the band counts includes a maximum band count for luma and a maximum band count for chroma; and the maximum band count for luma is greater than the maximum band count for chroma.

Example 31 provides the method of any one of examples 23-30, where performing the adaptive CCSO parameter search to determine the CCSO filtering decision includes reducing band counts to a subset of the band counts based on only a band-offset classifier being used for the frame; and evaluating the subset of the band counts based on one or more rate-distortion costs associated with the subset.

Example 32 provides the method of any one of examples 23-31, where performing the adaptive CCSO parameter search to determine the CCSO filtering decision includes skipping evaluation of a band-offset only mode based on the frame being the intra-frame or the anchor frame.

Example 33 provides the method of any one of examples 23-32, where performing the truncated CCSO parameter search to determine the CCSO filtering decision includes determining one or more CCSO filter parameter candidates used for one or more reference frames of the frame; and evaluating the one or more CCSO filter parameter candidates based on one or more rate-distortion costs associated with the one or more CCSO filter parameter candidates.

Example 34 provides an apparatus including means for performing a method according to any one of examples 23-33.

Example 35 provides a computer program product including instructions which, when executed by a processor, cause the processor to perform a method according to any one of examples 23-33.

Example 36 provides machine-readable storage including machine-readable instructions, which, when executed, cause a computer to implement a method according to any one of examples 23-33.

Example 37 provides a computer program including instructions which, when the computer program is executed by a processing device, cause the processing device to carry out a method according to any one of examples 23-33.

Example 38 provides a computer-implemented system, including one or more processors, and one or more non-transitory computer-readable media storing instructions that, when executed by the one or more processors, cause the one or more processors to perform a method according to any one of examples 23-33.

Example A provides an encoder to generate an encoded bitstream using operations described herein.

Example B provides an encoder to perform any one of the methods provided in examples 23-33 and methods/processes described herein.

Example C provides a CCSO filtering decision part 440 as described herein.

### VARIATIONS AND REMARKS

One or more functionalities of CCSO filtering decision part 440 and encoder 102 can be implemented as software instructions encoded in non-transitory computer-readable media, hardware logic or circuits, or both.

Although the operations of the example method shown in and described with reference to FIGS. 6-8 are illustrated as occurring once each and in a particular order, it will be recognized that some operations may be performed in any suitable order and repeated as desired. Additionally, one or more operations may be performed in parallel. Furthermore, the operations illustrated in FIGS. 6-8 or other FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, examples that may be practiced. It is to be understood that other examples may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order-dependent. In particular, these operations may not be performed in the order of presentation. Operations described may be performed in a different order from the described example. Various additional operations may be performed or described operations may be omitted in additional examples.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

For the purposes of the present disclosure, “A is less than or equal to a first threshold” is equivalent to “A is less than a second threshold” provided that the first threshold and the second threshold are set in a manner so that both statements result in the same logical outcome for any value of A. For the purposes of the present disclosure, “B is greater than a first threshold” is equivalent to “B is greater than or equal to a second threshold” provided that the first threshold and the second threshold are set in a manner so that both statements result in the same logical outcome for any value of B.

The description uses the phrases “in an example” or “in examples,” which may each refer to one or more of the same or different examples. The terms “comprising,” “including,” “having,” and the like, as used with respect to examples of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed is:

1. One or more non-transitory computer-readable media storing instructions that, when executed by one or more processors, cause the one or more processors to:
based on a frame type of a frame of a video being an intra-frame or an anchor frame, perform an adaptive cross-component sample offset (CCSO) search to determine a CCSO filtering decision;
based on the frame type being an inter-frame:
perform the adaptive CCSO parameter search to determine the CCSO filtering decision based on the frame meeting a complexity condition;
perform a truncated CCSO parameter search to determine the CCSO filtering decision based on the frame meeting a further complexity condition; and
set the CCSO filtering decision to disable filtering for the frame based on the frame meeting a yet further complexity condition; and
encode the frame using the CCSO filtering decision.

2. The one or more non-transitory computer-readable media of claim 1, wherein performing the adaptive CCSO parameter search to determine the CCSO filtering decision comprises:
selecting one or more CCSO filter parameter candidates based on a sharpness metric of the frame; and
evaluating the one or more CCSO filter parameter candidates based on one or more rate-distortion costs associated with the one or more CCSO filter parameter candidates.

3. The one or more non-transitory computer-readable media of claim 2, wherein the sharpness metric measures a percentage or proportion of blocks of the frame having a block variance exceeding a threshold.

4. The one or more non-transitory computer-readable media of claim 2, wherein selecting the one or more CCSO filter parameter candidates comprises selecting one or more of: a subset of supported scale indices, a subset of supported quantization steps, and a subset of supported filter shapes.

5. The one or more non-transitory computer-readable media of claim 1, wherein:
meeting the complexity condition comprises an encoded frame size of a lower-layer frame of the frame being within a range;
meeting the further complexity condition comprises the encoded frame size being within a further range; and
meeting a yet further complexity condition comprises the encoded frame size being within a yet further range;
wherein the range, the further range, and the yet further range are non-overlapping.

6. The one or more non-transitory computer-readable media of claim 1, wherein performing the adaptive CCSO parameter search to determine the CCSO filtering decision comprises:
reducing edge-offset quantizer types to a subset of the edge-offset quantizer types; and
evaluating the subset of the edge-offset quantizer types based on one or more rate-distortion costs associated with the subset.

7. The one or more non-transitory computer-readable media of claim 1, wherein performing the adaptive CCSO parameter search to determine the CCSO filtering decision comprises:
reducing band counts to a subset of the band counts based on a band-offset classifier and an edge-offset classifier being jointly used for the frame; and
evaluating the subset of the band counts based on one or more rate-distortion costs associated with the subset.

8. The one or more non-transitory computer-readable media of claim 7, wherein:
the subset of the band counts comprises a maximum band count for luma and a maximum band count for chroma; and
the maximum band count for luma is greater than the maximum band count for chroma.

9. The one or more non-transitory computer-readable media of claim 1, wherein performing the adaptive CCSO parameter search to determine the CCSO filtering decision comprises:
reducing band counts to a subset of the band counts based on only a band-offset classifier being used for the frame; and
evaluating the subset of the band counts based on one or more rate-distortion costs associated with the subset.

10. The one or more non-transitory computer-readable media of claim 1, wherein performing the adaptive CCSO parameter search to determine the CCSO filtering decision comprises:
skipping evaluation of a band-offset only mode based on the frame being the intra-frame or the anchor frame.

11. The one or more non-transitory computer-readable media of claim 1, wherein performing the truncated CCSO parameter search to determine the CCSO filtering decision comprises:
determining one or more CCSO filter parameter candidates used for one or more reference frames of the frame; and
evaluating the one or more CCSO filter parameter candidates based on one or more rate-distortion costs associated with the one or more CCSO filter parameter candidates.

12. An apparatus, comprising:
one or more processors; and
one or more non-transitory computer-readable media storing instructions that, when executed by the one or more processors, cause the one or more processors to:
based on a frame type of a frame of a video being an intra-frame or an anchor frame, perform an adaptive cross-component sample offset (CCSO) search to determine a CCSO filtering decision;
based on the frame type being an inter-frame:
perform the adaptive CCSO parameter search to determine the CCSO filtering decision based on the frame meeting a complexity condition;
perform a truncated CCSO parameter search to determine the CCSO filtering decision based on the frame meeting a further complexity condition; and
set the CCSO filtering decision to disable filtering for the frame based on the frame meeting a yet further complexity condition; and
encode the frame using the CCSO filtering decision.

13. The apparatus of claim 12, wherein performing the adaptive CCSO parameter search to determine the CCSO filtering decision comprises:
selecting one or more CCSO filter parameter candidates based on a sharpness metric of the frame; and
evaluating the one or more CCSO filter parameter candidates based on one or more rate-distortion costs associated with the one or more CCSO filter parameter candidates.

14. The apparatus of claim 13, wherein the sharpness metric measures a percentage or proportion of blocks of the frame having a block variance exceeding a threshold.

15. The apparatus of claim 13, wherein selecting the one or more CCSO filter parameter candidates comprises selecting one or more of: a subset of supported scale indices, a subset of supported quantization steps, and a subset of supported filter shapes.

16. The apparatus of claim 12, wherein:
meeting the complexity condition comprises an encoded frame size of a lower-layer frame of the frame being within a range;
meeting the further complexity condition comprises the encoded frame size being within a further range; and
meeting a yet further complexity condition comprises the encoded frame size being within a yet further range;
wherein the range, the further range, and the yet further range are non-overlapping.

17. The apparatus of claim 12, wherein performing the adaptive CCSO parameter search to determine the CCSO filtering decision comprises:
reducing edge-offset quantizer types to a subset of the edge-offset quantizer types; and
evaluating the subset of the edge-offset quantizer types based on one or more rate-distortion costs associated with the subset.

18. A method, comprising:
based on a frame type of a frame of a video being an intra-frame or an anchor frame, performing an adaptive cross-component sample offset (CCSO) search to determine a CCSO filtering decision;
based on the frame type being an inter-frame:
performing the adaptive CCSO parameter search to determine the CCSO filtering decision based on the frame meeting a complexity condition;
performing a truncated CCSO parameter search to determine the CCSO filtering decision based on the frame meeting a further complexity condition; and
setting the CCSO filtering decision to disable filtering for the frame based on the frame meeting a yet further complexity condition; and
encoding the frame using the CCSO filtering decision.

19. The method of claim 18, wherein performing the adaptive CCSO parameter search to determine the CCSO filtering decision comprises:
skipping evaluation of a band-offset only mode based on the frame being the intra-frame or the anchor frame.

20. The method of claim 18, wherein performing the truncated CCSO parameter search to determine the CCSO filtering decision comprises:
determining one or more CCSO filter parameter candidates used for one or more reference frames of the frame; and
evaluating the one or more CCSO filter parameter candidates based on one or more rate-distortion costs associated with the one or more CCSO filter parameter candidates.
